(19) United States
(12) Patent Application Publication
(10) Pub. No.: US 2019/0155851 A1
(43) Pub. Date: May 23, 2019

(54) INFORMATION FILTERING

(71) Applicant: TENCENT TECHNOLOGY (SHENZHEN) COMPANY LIMITED, Shenzhen (CN)

(72) Inventors: Xingya WANG, Shenzhen (CN); Qian Chen, Shenzhen (CN); Boen Liang, Shenzhen (CN); Jinzheng Zhang, Shenzhen (CN); Jianwei Yuan, Shenzhen (CN); Leming Fang, Shenzhen (CN); Chao Wan, Shenzhen (CN); Jilan Liang, Shenzhen (CN); Zijian He, Shenzhen (CN); Rui Tang, Shenzhen (CN); Zhike Liang, Shenzhen (CN); Xin Huang, Shenzhen (CN); Huankun Huang, Shenzhen (CN); Haixia Rao, Shenzhen (CN); Junwei Shen, Shenzhen (CN); Jun Zhang, Shenzhen (CN); Shuqin Sun, Shenzhen (CN); Pengfei Wang, Shenzhen (CN); Yingchao Liu, Shenzhen (CN); Wa Ye, Shenzhen (CN); Fei Huang, Shenzhen (CN); Jiasheng Huang, Shenzhen (CN); Zheqi Feng, Shenzhen (CN); Luting Chen, Shenzhen (CN); Shuwen Hu, Shenzhen (CN); Lingyun Xu, Shenzhen (CN)

(73) Assignee: TENCENT TECHNOLOGY (SHENZHEN) COMPANY LIMITED, Shenzhen (CN)

(21) Appl. No.: 16/260,571

(22) Filed: Jan. 29, 2019

Related U.S. Application Data
(63) Continuation of application No. PCT/CN2017/101138, filed on Sep. 8, 2017.

(30) Foreign Application Priority Data
Sep. 9, 2016 (CN) 201610814454.1
Sep. 9, 2016 (CN) 201610816181.4
Sep. 26, 2016 (CN) 201610852629.8

(51) Int. Cl. G06F 16/9035; G06F 16/951; G06F 16/9536

(52) U.S. Cl. CPC G06F 16/9035; G06F 16/9536; G06F 16/951

(57) ABSTRACT

This application discloses an information filtering method and an information processing apparatus. Shared information that is shared by a user account of an online service is obtained. A credibility reference rating associated with the user account is obtained. The credibility reference rating indicates account credibility of the user account. Whether the shared information satisfies a filtering condition is determined based on the credibility reference rating. Further, the shared information is filtered when the shared information is determined to satisfy the filtering condition.

### RELATED APPLICATION

This application is a continuation of International Application No. PCT/CN2017/101138, filed on Sep. 8, 2017, which claims priorities to Chinese Patent Application No. 201610814454.1, entitled “INFORMATION FILTERING METHOD AND APPARATUS” filed with the Chinese Patent Office on Sep. 9, 2016, Chinese Patent Application No. 201610816181.4, entitled “TRANSACTION CONTROL METHOD AND APPARATUS” filed with the Chinese Patent Office on Sep. 9, 2016, and Chinese Patent Application No. 201610852629.8, entitled “SERVICE PROCESSING METHOD AND APPARATUS” filed with the Chinese Patent Office on Sep. 26, 2016. The entire disclosures of the prior applications are hereby incorporated by reference in their entirety.

### FIELD OF THE TECHNOLOGY

Embodiments of this application relate to the field of Internet technologies.

### BACKGROUND OF THE DISCLOSURE

Social application programs usually provide social application sharing platform services. When a user releases updating information on a social application sharing platform of the user, a server of the social application program displays the updating information, such as forwarding the updating information to friend users in a friend relationship chain of the user, so that social application sharing platforms of the friend users can display the updating information. Certainly, this type of updating information may be not only forwarded to the friend users, but also forwarded to a public platform when a reading right of the updating information is set to being visible to all, so that any user can see the updating information.

However, updating information released by users may be junk information such as reactionary information and political negative information. To reduce propagation of junk information, a server usually filters junk information in received updating information. Currently, a common method is to filter by means of key word matching. Specifically, the server matches received updating information against key words in a key word bank. If the updating information matches a key word in the key word bank, the server determines that the updating information is junk information and filters the junk information, which is not forwarded to friend users, thereby avoiding propagation of junk information.

Key words included in the key word bank are relatively limited, and therefore junk information filtered by means of key word matching is also relatively limited, and filtering on junk information is not complete enough.

### SUMMARY

According to aspects of the application, an information filtering method is provided. Shared information that is shared by a user account of an online service is obtained. A credibility reference rating associated with the user account is obtained. The credibility reference rating indicates account credibility of the user account. Whether the shared information satisfies a filtering condition is determined based on the credibility reference rating. Further, the shared information is filtered when the shared information is determined to satisfy the filtering condition.

According to aspects of the application, an information processing apparatus is provided. The information processing apparatus includes processing circuitry. The processing circuitry is configured to obtain shared information that is shared by a user account of an online service, and obtain a credibility reference rating associated with the user account. The credibility reference rating indicates account credibility of the user account. The processing circuitry is configured to determine whether the shared information satisfies a filtering condition based on the credibility reference rating, and filter the shared information when the shared information is determined to satisfy the filtering condition.

According to an aspect of the application, a non-transitory computer-readable storage medium is provided. The non-transitory computer-readable storage medium stores a program executable by a processor to perform obtaining shared information that is shared by a user account of an online service. The program causes the processor to perform obtaining a credibility reference rating associated with the user account. The credibility reference rating indicates account credibility of the user account. The program causes the processor to perform determining whether the shared information satisfies a filtering condition based on the credibility reference rating, and filtering the shared information when the shared information is determined to satisfy the filtering condition.

The technical solutions provided in the embodiments of this application bring the following beneficial effects:

Updating information is obtained, whether the updating information meets a filter condition (or a filtering condition) is detected according to a credibility reference value associated with a user account that releases the updating information, and the updating information is filtered when the updating information meets the filter condition, so that the problem that is of incomplete filtering on junk information and that is caused by limited key words when information filtering is performed by means of key word matching is resolved. Usually, the probability of releasing junk information by a user account having relatively high credibility is relatively low, and the probability of releasing junk information by a user account having relatively low credibility is relatively high. Therefore, filtering updating information released by a user account according to a credibility reference value of the user account makes filtering on junk information more complete.

### BRIEF DESCRIPTION OF THE DRAWINGS

To describe the technical solutions in the embodiments of this application more clearly, the following briefly describes the accompanying drawings used for describing the embodiments. The accompanying drawings in the following description show merely some embodiments of this application, and a person of ordinary skill in the art may still derive other drawings from these accompanying drawings.

FIG. 1 is a schematic diagram of an implementation environment according to various embodiments of this application;

FIG. 2 is a schematic diagram of another implementation environment according to various embodiments of this application;

FIG. 3 is a flowchart of an information filtering method according to an exemplary embodiment of this application;

FIG. 4 is a flowchart of an information filtering method according to another exemplary embodiment of this application;

FIG. 5 is a flowchart of an information filtering method according to another exemplary embodiment of this application;

FIG. 6 is a flowchart of an information filtering method according to another exemplary embodiment of this application;

FIG. 7 is a flowchart of an information filtering method according to another exemplary embodiment of this application;

FIG. 8A is a schematic diagram of an information filtering method according to another exemplary embodiment of this application;

FIG. 8B is a schematic diagram of an information filtering method according to another exemplary embodiment of this application;

FIG. 9 is a block diagram of an information filtering apparatus according to another exemplary embodiment of this application;

FIG. 10 is a schematic structural diagram of a social application server according to another embodiment of this application;

FIG. 11 is a schematic diagram of an implementation environment according to an embodiment of this application;

FIG. 12 is a flowchart of a transaction control method according to an embodiment of this application;

FIG. 13 is a flowchart of a transaction control method according to another embodiment of this application;

FIG. 14 is a block diagram of a transaction control apparatus according to an embodiment of this application;

FIG. 15 is a block diagram of a transaction control apparatus according to another embodiment of this application;

FIG. 16 is a schematic structural diagram of a terminal according to an embodiment of this application;

FIG. 17A is a flowchart of a service processing method according to an embodiment of this application;

FIG. 17B is a flowchart of a service processing method according to an embodiment of this application;

FIG. 17C is a display schematic diagram of a value accumulation message according to an embodiment of this application;

FIG. 17D is a display schematic diagram of details of an accumulated value according to an embodiment of this application;

FIG. 17E is a display schematic diagram of details of an accumulated value according to an embodiment of this application;

FIG. 17F is a display schematic diagram of a payment success message according to an embodiment of this application;

FIG. 17G is a schematic diagram of a thankyou interface of activity participation according to an embodiment of this application;

FIG. 17H is a display schematic diagram of an activity recommendation message according to an embodiment of this application;

FIG. 17I is a display schematic diagram of a transfer option of an accumulated value according to an embodiment of this application;

FIG. 17J is a display schematic diagram of a transfer option of an accumulated value according to an embodiment of this application;

FIG. 17K is a schematic diagram of an interface for virtual resource redemption according to an embodiment of this application;

FIG. 18 is a block diagram of a service processing apparatus according to an embodiment of this application; and

FIG. 19 is a block diagram of a service processing apparatus according to an embodiment of this application.

### DESCRIPTION OF EMBODIMENTS

To make the objectives, technical solutions, and advantages of this application clearer, the following further describes the implementations of this application in detail with reference to the accompanying drawings.

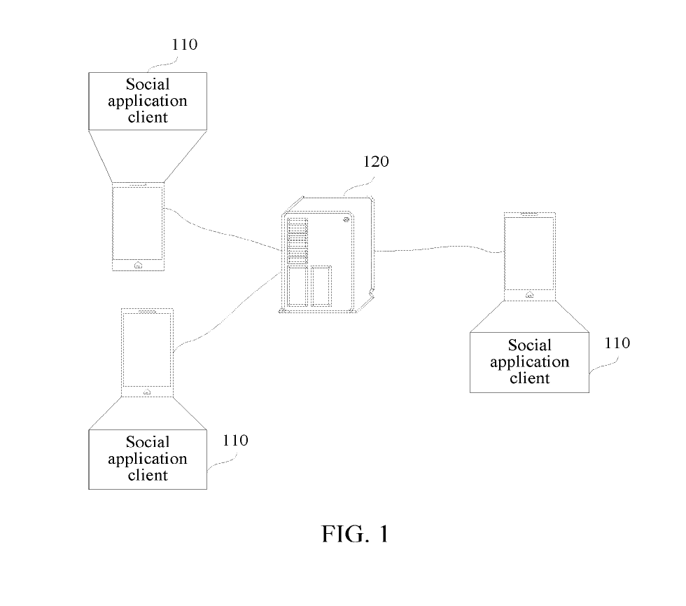

Referring to FIG. 1, FIG. 1 is a schematic diagram of an implementation environment according to an exemplary embodiment of this application. The implementation environment includes: at least two social application clients 110 and a social application server 120. In an example, the social application server 120 is an information processing apparatus.

The social application client 110 is a social application client that provides a social service for a user. The social application client may run in a terminal device such as a mobile phone, a tablet computer, a portable computer, or a desktop computer. Optionally, the social application client 110 may be a client of a network social application program, or another client having a social attribute, such as a shopping client, a game client, a reading client, or a video sharing client. FIG. 1 schematically shows three social application clients 110.

The social application client 110 includes a social application sharing platform. When logging in to a user account by using the social application client 110, the user may release updating information (or shared information) on the social application sharing platform by using the user account. In an example, the user has the user account of an online service. The updating information is also displayed on a social application sharing platform of a user account (or a target user account) having a friend relationship with the user account. In an example, the target user account is related to the user account. For example, a user account 1 has friend relationships with a user account 2 and a user account 3, and then when the user account 1 releases updating information on a social application sharing platform, the updating information may also be displayed on social application sharing platforms of the user account 2 and the user account 3.

Note that the friendship may also a relationship such as follow or subscription. For example, a friend relationship existing between the user account 1 and the user account 2 may be that the user account 1 follows the user account 2 or the user account 2 follows the user account 1. The follow or subscription may be one unidirectional or bidirectional. This is not specifically limited herein.

The social application server 120 is a background server that provides a service for the social application client 110. The social application server 120 may be a server, a server cluster composed of several servers, or a cloud computing service center. Optionally, the social application server 120 includes a server configured to implement a social application sharing platform, a server configured to generate a credit score of a user account, and a server configured to manage and store credit scores of user accounts.

Optionally, the social application server 120 obtains at least one of online behavior data, offline behavior data, and bank reference data of a user account from a local credit providing platform or a reliable third-party credit providing mechanism on the premise of authorization by the user account, and generates a credit score of the user account according to obtained data. Optionally, the social application server 120 separately extracts a characteristic variable from the obtained data, inputs the extracted characteristic variable into a preset credit model, generates a credit score corresponding to a user account, and stores each user account and a credit score corresponding thereto as a preset correspondence. The preset credit model may be a model obtained by training by using bank reference data of each user account as a training sample.

The online behavior data and the offline behavior data include but are not limited to:

1. Financial credit data: wealth management data, stock data, fund data, and the like;

2. Payment data: account balance payment, bank card quick payment, credit payment, bookkeeping and delayed payment, and the like;

3. Shopping data: online shopping data and offline shopping data;

4. Basic attribute data: name, age, gender, district, education, occupation, and the like;

5. Social behavior data: chatting data, released updating information, email data, voice call data, and the like;

6. Entertainment behavior data, such as video on demand data, music play data, and reading data;

7. Education behavior data, such as open class learning reading data, professional examination exercise reading data, skill training reading data, and translation software use reading data;

8. Other social behavior data: life service data, wearable device data, geographical location data, travelling data, and the like.

In addition, this application further provides a credibility reference value (or a credibility reference rating). In an example, a credibility reference value indicates account credibility of a user account. The credibility reference value is used to indicate the transaction credibility of a user account (that is, a user corresponding to the user account) or the credibility of information released by the user account. For example, the credibility reference value is in a positive correlation with the transaction credibility of the user account. A larger credibility reference value indicates a higher transaction credibility of the user account. A smaller credibility reference value indicates a lower transaction credibility of the user account. In this embodiment of this application, the scoring method for the credibility reference value is not limited, and may be a hundred-mark system, a ten-point system, a normalization method, or the like.

The credibility reference value may be determined according to a credit score. In an example, the credibility reference value is determined by combining the credit score and reference information. The reference information includes but is not limited to at least one of the following: historical transaction behavior data of a user account and object information released by a user account. The historical transaction behavior data is data that is of the user account and that is of historical transaction behaviors in a transaction platform involved in the technical solution provided in this example of this application. The object information is information of a to-be-transacted object, and includes but is not limited to any one of the following: information of a to-be-exchanged-out object, information of a to-be-exchanged-in object, information of a to-be-sold object, and information of a to-be-purchased object. In this example of this application, the type of the object is not limited. The object may be a physical object, or a virtual object.

The social application client 110 may establish a communications connection to the social application server 120 in a wireless network manner or a wired network manner.

Optionally, the foregoing wireless network or wired network uses a standard communication technology and/or protocol. The network is usually the Internet, or may be any network, including but not limited to a local area network (LAN), a metropolitan area network (MAN), a wide area network (WAN), or any combination of a mobile, wired, or wireless network, a private network, or a virtual private network. In some embodiments, technologies and/or formats including Hypertext Markup Language (HTML), Extensible Markup Language (XML), and the like are used to represent data exchanged by using the network. In addition, conventional encryption technologies such as Secure Socket Layer (SSL), Transport Layer Security (TLS), VPN, and Internet Protocol Security (IPsec) are used to encrypt all or some links. In some other embodiments, customized and/or dedicated data communications technologies may alternatively be used to replace or supplement the foregoing data communications technologies.

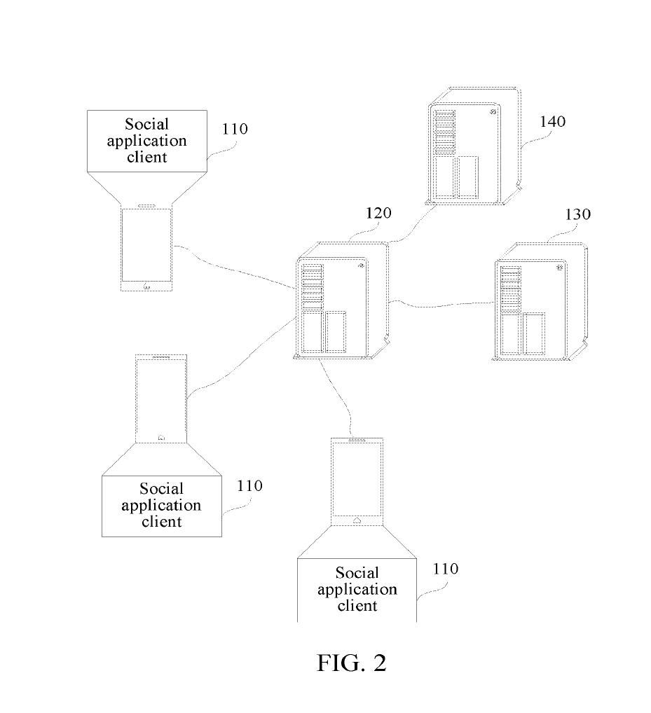

Optionally, in other exemplary embodiments, the social application server 120 may not include the server configured to calculate a credit score of a user account and the server configured to manage and store credit scores of user accounts. Instead, a dedicated first credit server 130 calculates, manages, and stores a credit score. Then the implementation environment may further include the first credit server 130, as shown in FIG. 2.

The first credit server 130 may be a server, a server cluster composed of several servers, or a cloud computing service center. Optionally, the first credit server 130 includes a server configured to generate credit scores of user accounts, and a server configured to manage and store the credit scores of the user accounts. Reference may be made to the method for generating a credit score by the social application server 120 for the method for calculating a credit score of a user account by the first credit server 130. Details are not described in this embodiment again.

The first credit server 130 may establish a communications connection to the social application server 120 in a wireless network manner or a wired network manner.

Alternatively, as shown in FIG. 2, optionally, in other exemplary embodiments, the implementation environment may alternatively include a second credit server 140.

The second credit server 140 is usually a dedicated server of a credit providing mechanism. The second credit server 140 may obtain at least one of online behavior data, offline behavior data, and bank reference data of a user by using real name information of the user, and generate a credit score of the real name information of the user according to the obtained data. Reference may be made to the method for generating a credit score by the social application server 120 for the method for calculating a credit score of real name information of a user by the second credit server 140 by using obtained data. Details are not described in this embodiment again.

The second credit server 140 may be a server, a server cluster composed of several servers, or a cloud computing service center. Optionally, the second credit server 140 includes a server configured to generate credit scores of real name information of users, and a server configured to manage and store the credit scores of real name information of users.

The second credit server 140 may establish a communications connection to the social application server 120 in a wireless network manner or a wired network manner.

Referring to FIG. 3, FIG. 3 is a flowchart of an information filtering method according to an embodiment of this application. In this embodiment, applying the method to the social application server shown in FIG. 1 or FIG. 2 is used as an example for description. In this case, released information is updating information released by a user, and a credibility reference value may be specifically a credit score for exemplary description. The method includes the following several steps:

In Step 301, a social application server obtains updating information.

Optionally, the updating information is updating information in a social application sharing platform of a social application client. When receiving an obtaining request sent by a target user account, the social application server obtains the updating information. The updating information is updating information released by a user account in a friend relationship chain of the target user account in the social application sharing platform.

Optionally, the updating information includes at least one of text information, picture information, video information, and web page link information. For example, the updating information may be a combination of text information and picture information.

In Step 302, the social application server obtains a credit score of a user account that releases the updating information.

The credit score is used to represent a credit of a user account. The credit score may be generated in real time based on current related data of the user account, or may be regenerated every preset period, and stored into the social application server, so as to be obtained during information filtering.

Optionally, the credit score of a user account is a credit value represented by using a quantitative value. A higher credit value represents better credit, represented by the credit score, of the user account.

Optionally, credit scores are credit levels represented by using superior and inferior levels. Credit levels include excellent, good, bad, very bad, and the like. Usually, among the credit levels, excellent>good>bad>very bad. A higher credit level indicates better credit, represented by the credit level, of the user account. Certainly, the credit level may also be expressed in a value form, such as level 1, level 2, or level 3. The relationship between the value and the credit status may be set by a technician, and may be set to that a larger value indicates better credit, or may be set to that a smaller value indicates poorer credit.

This step has three different implementations:

In a first implementation, the information filtering method is applied to the social application server shown in FIG. 1. The social application server has capabilities of generating, managing, and storing credit scores of user accounts, and the social application server pre-generates and stores a preset correspondence between user accounts and credit scores. Then the method is implemented as: querying, by the social application server, a credit sore corresponding to a user account from the preset correspondence, the preset correspondence including a correspondence between user accounts and credit scores. In the present implementation, data processing is controllable, and an obtained delay is relatively small. Before generating and storing the preset correspondence, the social application server may first obtain various data for generating a credit score, and then generate the credit score based on the data.

In a second implementation, the information filtering method is applied to the social application server shown in FIG. 2. A first credit server implements functions of generating, managing, and storing credit scores of user accounts. Then the method is implemented as: sending, by the social application server, a query request to the first credit server, the query request carrying a user account; and receiving a credit score that corresponds to the user account and that is fed back by the first credit server. The present implementation can greatly reduce data processing pressure of the social application server.

In a third implementation, the information filtering method is applied to the social application server shown in FIG. 2. A second credit server implements functions of generating, managing, and storing credit levels corresponding to real name information of users. Then the method is implemented as: sending, by the social application server, a query request to the second credit server, the query request carrying real name information of a user of a user account; and receiving a credit score that corresponds to the real name information and that is fed back by the second credit server. The present implementation can greatly reduce data processing pressure of the social application server.

Any one of the foregoing implementations may further be combined with another implementation. For example, the first implementation may be combined with any one of the second and third implementations. For some specified users, the first implementation is used to reduce a delay, and for users other than the specified users, the second or third implementation is used, to reduce occupation of a storage space by the social application server. The specified users may be users whose user levels are higher than a particular level. The specific level may be set by a technician based on actual service requirements. Details are not described herein.

In step 303, the social application server detects, according to the credit score, whether the updating information meets a filter condition (or a filtering condition).

In step 304, when the updating information meets the filter condition, the social application server filters the updating information.

Optionally, filtering the updating information is deleting the updating information, or not sending the updating information to another user account after the updating information is received. For example, when updating information released by a user is received and it is determined that the updating information meets a filter condition, the updating information is deleted; or when updating information is obtained and it is determined that the updating information meets a filter condition, the updating information that meets the filter condition is deleted from the obtained updating information, to avoid transmission; or when updating information released by a user is received and it is determined that the updating information meets a filter condition, the updating information is stored into a filter database, and updating information stored in the filter database is displayed only to a user that releases the information, and is not sent to another user account. Certainly, the filtering may alternatively be adding a status label to updating information, to indicate that the updating information is not sent to another user account. Once detecting the status label, the social application server does not send the updating information.

After receiving updating information released by a user account, the social application server sends the updating information to each target user account. Therefore, optionally, the social application server filters updating information sent to each target user account. The target user account is a user account in a friend relationship chain of the user account.

Based on the above, according to the information filtering method provided in this embodiment of this application, updating information is obtained, whether the updating information meets a filter condition is detected according to a credit score of a user account that releases the updating information, and the updating information is filtered when the updating information meets the filter condition, so that the problem that is of incomplete filtering on junk information and that is caused by limited key words when information filtering is performed by means of key word matching is resolved. Usually, the probability of releasing junk information by a user account having relatively high credit is relatively low, and the probability of releasing junk information by a user account having relatively low credit is relatively high. Therefore, filtering updating information released by a user account according to a credit score of the user account makes filtering on junk information more complete.

In this embodiment of this application, the filter condition includes at least one of the following filter conditions:

The first filter condition: a credit score of a user account is less than a preset indicator.

The second filter condition: a sending index (or a release index) determined according to a credit score of a user account and first quality information of updating information is less than a preset threshold, where the first quality information is determined by the social application server according to the updating information. In an example, the first quality information indicates information credibility of the updating information.

The third filter condition: a sending index determined according to a credit score of a user account and second quality information of updating information is less than a preset threshold, where the second quality information is determined by the social application server according to the updating information and each piece of updating information released by the user account.

The fourth filter condition: a sending index determined according to a credit score of a user account, and first quality information and second quality information of updating information is less than a preset threshold.

The foregoing four cases are respectively described in detail below in different embodiments.

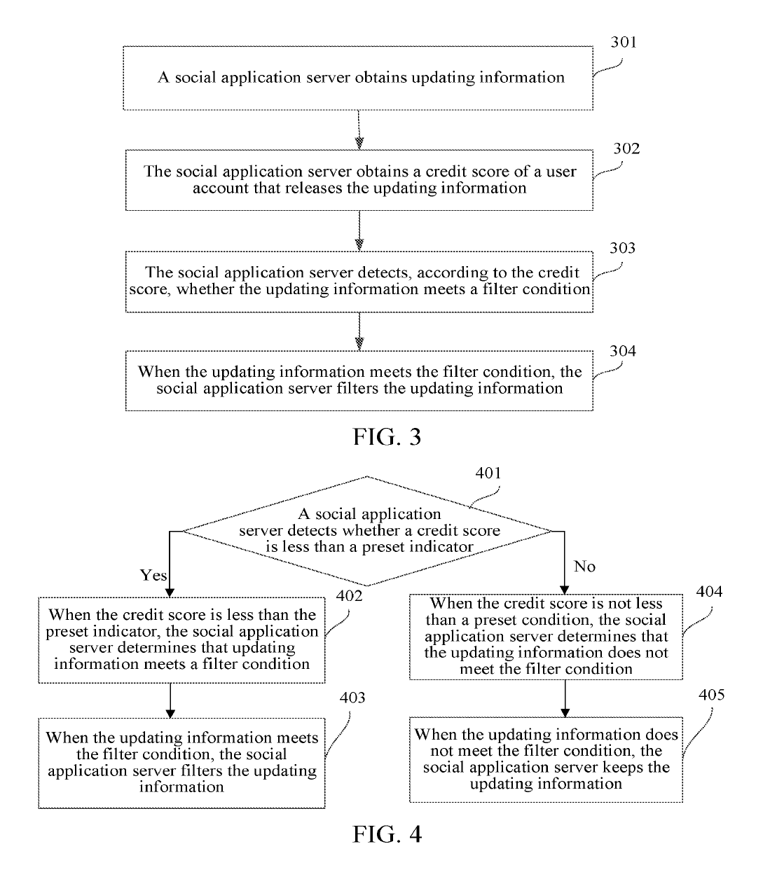

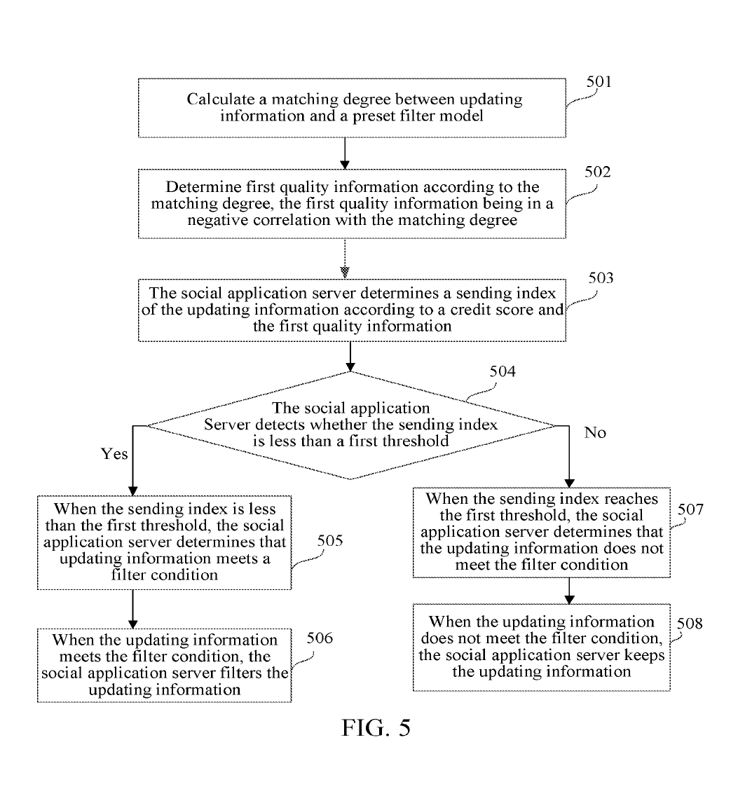

When the filter condition is the first filter condition, step 303 and step 304 include the following several steps, as shown in FIG. 4:

In step 401, a social application server detects whether a credit score is less than a preset indicator.

Optionally, when the credit score is a credit value and the preset indicator is a preset value threshold, the method is implemented as calculating whether the credit value is less than the preset value threshold, where the preset value threshold is a system preset value or a user-defined value. For example, the preset value threshold is 300.

Optionally, when the credit score is a credit level and the preset indicator is a preset level threshold, the method is implemented as calculating whether the credit level is less than the preset level threshold, where the preset level threshold is preset by a system or user-defined. For example, the preset level threshold is good.

In step 402, when the credit score is less than the preset indicator, the social application server determines that updating information meets a filter condition.

Optionally, when the credit value is less than the preset value threshold, it is determined that the updating information meets the filter condition. For example, when a credit value of a user account is 190, the social application server detects that the credit value is less than 300, and determines that the updating information meets the filter condition.

Optionally, when the credit level is less than the preset level threshold, it is determined that the updating information meets the filter condition. For example, when a credit level of a user account is very bad, the social application server detects that the credit level is lower than good, and determines that the updating information meets the filter condition.

When the credit score is less than the preset indicator, it indicates that the credit of a user account is relatively low. Because a user with a low credit is usually more likely to release junk information, it is determined that updating information released by a user account whose credit score is less than a preset condition meets the filter condition.

In step 403, when the updating information meets the filter condition, the social application server filters the updating information.

In step 404, when the credit score is not less than a preset condition, the social application server determines that the updating information does not meet the filter condition.

In step 405, when the updating information does not meet the filter condition, the social application server keeps the updating information.

Based on the above, according to the information filtering method provided in this embodiment of this application, updating information is obtained, whether the updating information meets a filter condition is detected according to a credit score of a user account that releases the updating information, and the updating information is filtered when the updating information meets the filter condition, so that the problem that is of incomplete filtering on junk information and that is caused by limited key words when information filtering is performed by means of key word matching is resolved. Usually, the probability of releasing junk information by a user account having relatively high credit is relatively low, and the probability of releasing junk information by a user account having relatively low credit is relatively high. Therefore, filtering updating information released by a user account according to a credit score of the user account makes filtering on junk information more complete.

According to the information filtering method provided in this embodiment of this application, updating information released by a user account is filtered according to a credit score of a user account, so that the problem that is of filtering useful updating information and that is caused by misjudging information that includes the key word but has the actual expressed content that is not inappropriate content as junk information when junk information is filtered by means of key word matching is resolved, thereby improving the accuracy of identifying and filtering junk information.

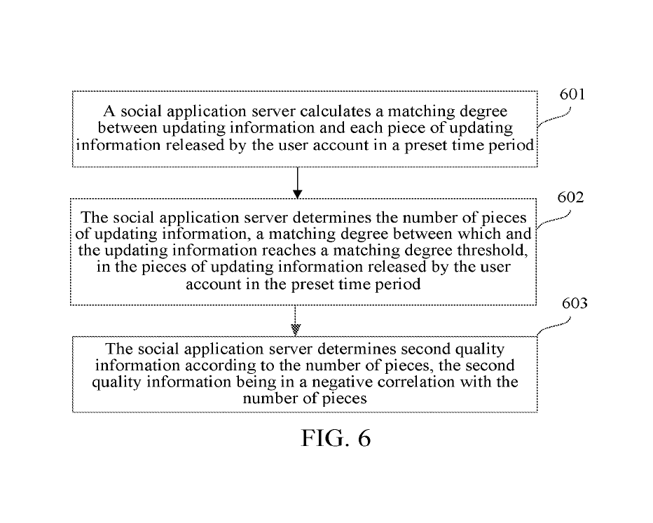

Optionally, when the filter condition is the second filter condition, step 303 and step 304 in the embodiment shown in FIG. 3 include the following several steps, as shown in FIG. 5:

In step 501, a social application server calculates a matching degree between updating information and a preset filter model.

The social application server pre-obtains an information sample, and obtains the preset filter model by training according to the information sample. The information sample is a reactionary information sample, a rumor information sample, a political negative information sample, or the like.

The social application server obtains a characteristic variable of the updating information, and inputs the characteristic variable into the preset filter model, to obtain a matching degree between the updating information and the preset filter model. A higher matching degree indicates a higher probability that the updating information is junk information.

In step 502, the social application server determines first quality information according to the matching degree, the first quality information being in a negative correlation with the matching degree.

There is a preset correspondence between the matching degree and the first quality information. After determining the matching degree of the updating information, the social application server queries the preset correspondence, and determines the first quality information corresponding to the matching degree. Optionally, the first quality information is a quality value represented by using a quantitative value. For example, the matching degree calculated by the social application server is 70%, and the first quality information determined by the social application server is 30; the matching degree calculated by the social application server is 20%, and the first quality information determined by the social application server is 80.

In step 503, the social application server determines a sending index of the updating information according to a credit score and the first quality information.

The sending index is in a positive correlation with the credit score and the first quality information. Optionally, when the credit score is a credit value and the first quality information is a quality value, the sending index is a sum or a product of the credit score and the first quality information.

In step 504, the social application server detects whether the sending index is less than a first threshold, and if yes, performs step 505, and if not, performs step 507.

The first threshold is system preset value or a user-defined value, and is not limited in this embodiment.

In step 505, when the sending index is less than the first threshold, the social application server determines that updating information meets a filter condition.

In step 506, when the updating information meets the filter condition, the social application server filters the updating information, and the flow ends.

In step 507, when the sending index reaches the first threshold, the social application server determines that the updating information does not meet the filter condition.

In step 508, when the updating information does not meet the filter condition, the social application server keeps the updating information.

Based on the above, according to the information filtering method provided in this embodiment of this application, first quality information of updating information is obtained by matching the updating information against a preset filter model, a sending index of the updating information is comprehensively determined according to the first quality information and a credit score of a user account, and the updating information is filtered or kept according to the sending index, so that the problem of failing to identify junk information that cannot be easily identified such as rumor information and false information when filtering is performed by means of key word matching is resolved, the coverage of identified junk information is wider, and the filtering on the junk information is more comprehensive.

Optionally, when the filter condition is the third filter condition, step 501 and step 502 may be replaced with the following several steps, as shown in FIG. 6:

In step 601, a social application server calculates a matching degree between updating information and each piece of updating information released by the user account in a preset time period.

The preset time period is a time period preset by a system or a user-defined time period. Optionally, the preset time period is a time period having a preset duration before time when a user account releases the updating information. For example, if the user account releases the updating information at 14:00, the preset time period may be 13:50-14:00.

Optionally, the social application server calculates a matching degree between the updating information and each piece of updating information that is released by the user account in the preset time period and that belongs to a category the same as that of the updating information. For example, when the updating information is text information, a matching degree between the text information and each piece of text information released by the user account in the preset time period is calculated. For another example, when the updating information is web page link information, a matching degree between content corresponding to the web page link information and content corresponding to each piece of web page link information released by the user account in the preset time period is calculated.

In step 602, the social application server determines the number of pieces of updating information, a matching degree between which and the updating information reaches a matching degree threshold, in the pieces of updating information released by the user account in the preset time period.

The matching degree threshold is a system preset value or a user-defined value. The value of the matching degree threshold is not limited in this embodiment.

For example, the user account releases updating information 1, updating information 2, and updating information 3. Upon calculation, the social application server obtains that a matching degree between the updating information 4 released by the user account and the updating information 1 is 62%, a matching degree between the updating information 4 and the updating information 2 is 60%, and a matching degree between the updating information 4 and the updating information 3 is 55%. Assuming that the matching degree threshold is 50%, the social application server determines that the number of pieces of updating information, between which and the updating information reaches the matching degree threshold is three.

In step 603, the social application server determines second quality information according to the number of pieces, the second quality information being in a negative correlation with the number of pieces.

There is a preset correspondence between the number of pieces and the second quality information. After determining the number of pieces, the social application server queries the preset correspondence, to determine the second quality information corresponding to the number of pieces. For example, if the number of pieces that is determined by the social application server is three, the second qualify information determined by the social application server is 50; if the number of pieces that is determined by the social application server is one, the second quality information determined by the social application server is 85.

Based on the above, according to the information filtering method provided in this embodiment of this application, second quality information of updating information is obtained by matching updating information against each piece of updating information released by a user account, a sending index of the updating information is comprehensively determined according to the second quality information and a credit score of the user account, and the updating information is filtered or kept according to the sending index, so that the problem of failing to identify a large amount of meaningless spamming information when filtering is performed by means of key word matching is resolved, the coverage of identified junk information is wider, and the filtering on the junk information is more comprehensive.

Optionally, when the filter condition is the fourth filter condition, step 501 to step 503 may be replaced with the following several steps:

First, a matching degree between updating information and a preset filter module is calculated. First quality information is determined according to the matching degree. The first quality information is in a negative correlation with the matching degree.

Then, a matching degree between updating information and each piece of updating information released by the user account in a preset time period is calculated. The number of pieces of updating information, a matching degree between which and the updating information reaches a matching degree threshold, in the pieces of updating information released by the user account in the preset time period is determined. Second quality information is determined according to the number of pieces. The second quality information is in a negative correlation with the number of pieces.

Finally, a sending index of the updating information is determined according to a credit score, the first quality information, and the second quality information.

In this embodiment of this application, the sending index is in a positive correlation with a sum of the credit score, the first quality information, and the second quality information. Optionally, when the credit score is a credit value and the first quality information is a quality value, the sending index is a sum or a product between a sum of the first quality information and the second quality information and the credit score. Certainly, in actual scenarios, a piece of new quality information may alternatively be obtained based on the first quality information and the second quality information. The specific obtaining manner may be separately assigning a weight to the first quality information and the second quality information, and then performing weighted calculation on the first quality information and the second quality information, to obtain the new quality information. The sending index is in a positive correlation with the credit score and the new quality information.

Based on the above, the information filtering method provided in this embodiment of this application resolves the problem of failing to identify a large amount of meaningless spamming information when filtering is performed by means of key word matching, so that the coverage of identified junk information is wider, and the filtering on the junk information is more comprehensive. Further, filtering on junk information can be enabled to be more accurate and appropriate by comprehensively considering information such as the number of pieces and the matching degree.

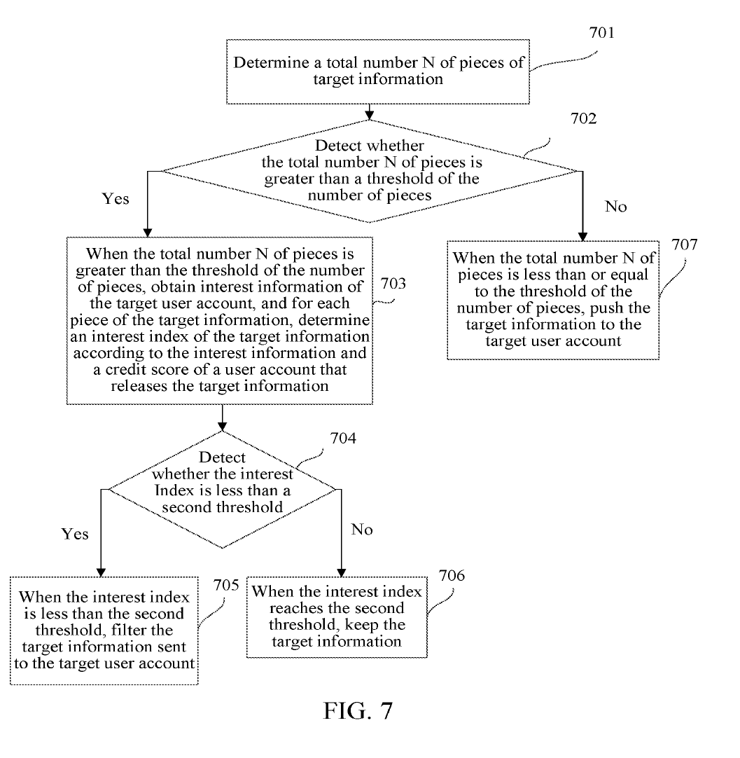

Optionally, after the social application server filters junk information by using the information filtering method shown in any one of the embodiments of FIG. 3 to FIG. 6, for any target user account in a friend relationship chain of a user account, if there is a relatively large amount of updating information needing to be sent to the target user account, the social application server may filter the updating information sent to the target user account again, including the following several steps, as shown in FIG. 7:

In step 701, the social application server determines a total number N of pieces of target information.

The target information is updating information, which does not meet a filter condition, in the updating information sent to the target user account, and the target user account is a user account used to display the updating information. N is an integer greater than or equal to 0.

In step 702, the social application server detects whether the total number N of pieces is greater than a threshold of the number of pieces.

The threshold of the number of pieces is a system preset value or a user-defined value.

In step 703, when the total number N of pieces is greater than the threshold of the number of pieces, the social applications server obtains interest information of the target user account, and for each piece of the target information, determines an interest index of the target information according to the interest information and a credit score of a user account that releases the target information.

The interest index is used to represent a degree of interest of a user of the target user account on the target information.

When the total number of pieces of the target information is greater than the threshold of the number of pieces, if the social application server directly sends all the target information to the target user account, overload is easily caused due to an excessive amount of information. In addition, when there are a relatively large number of pieces of the target information, the effect of displaying the target information by a social application sharing platform of the target user account is also relatively poor. Therefore, after filtering junk information in the updating information, the social application server may further filter the target information again according to different degrees of interest of the user of the target user account on the target information. The total number of pieces of filtered target information is less than or equal to the threshold of the number of pieces.

Optionally, the social application server obtains interest information of the target user by obtaining a preset interest model corresponding to the target user account. The preset interest model is obtained in the following manner: the social application server pre-obtains an interest sample of the target user account, and trains according to the interest sample, to obtain the preset interest model corresponding to the target user account. Optionally, the interest sample includes data about access to each piece of historically displayed updating information. The data about access includes at least one of the number of access, by the target user account, to updating information, the number of interaction on the updating information, and a stay duration of the access to the updating information. Usually, a larger number of access, by the target user account, to the updating information, a larger number of interaction on the updating information, and a longer stay duration of the access to the updating information indicate a higher degree of interest of the target user account on the updating information. The social application server trains according to degrees of interest of the target user account on different updating information, to obtain the preset interest model.

The social application server extracts a characteristic variable of the target information, and inputs the characteristic variable into the preset interest model, to obtain a matching value of the target information. A higher matching value indicates a higher degree of interest of the target user account on the target information.

The interest index is in a positive correlation with the matching value and a credit score. Optionally, when the credit score is a credit value, the interest index is a sum or product of the matching value and the credit value.

In step 704, the social application server detects whether the interest index is less than a second threshold.

The second threshold is a system preset value or a user-defined value, and may be used to distinguish whether a user is interested in information.

In step 705, when the interest index is less than the second threshold, the social application server filters the target information sent to the target user account.

After filtering the target information, the social application server sends the remaining target information to the target user account.

Note that in actual implementation, the social application server may alternatively filter the target information according to the matching value. That is, when the matching value is less than the preset threshold, the target information is filtered. The preset threshold herein is a system preset value or a user-defined value, is not limited in this embodiment.

In step 706, when the interest index reaches the second threshold, the social application server keeps the target information.

In step 707, when the total number N of pieces is less than or equal to the threshold of the number of pieces, the social application server sends the target information to the target user account.

Based on the above, according to the information filtering method provided in this embodiment of this application, when the number of pieces of target information is greater than a threshold of the number of pieces, target information, on which a degree of interest of a target user account is relatively low is filtered according to different degrees of interest of the target user account on the target information, so that the number of pieces of sent updating information is reduced, the load of the social application server is reduced, and the display effect of the target information is better.

Certainly, to ensure a more comprehensive filtering effect, the information filtering method provided in this embodiment of this application may alternatively be implemented in combination with the key word filtering manner. For example, some preset key words are added into a process of training a preset filter model, and then the preset filter model is used for calculating a matching degree; or, before filtering based on a filter condition is performed, key word filtering is first performed; or, after the filtering based on the filter condition is performed, the key word filtering is performed, so that a better filtering effect can be achieved. In addition, because the preset key words may be updated with active updating of technicians, they can be used as a good supplement, so that some newly appearing junk words and the like are filtered in time.

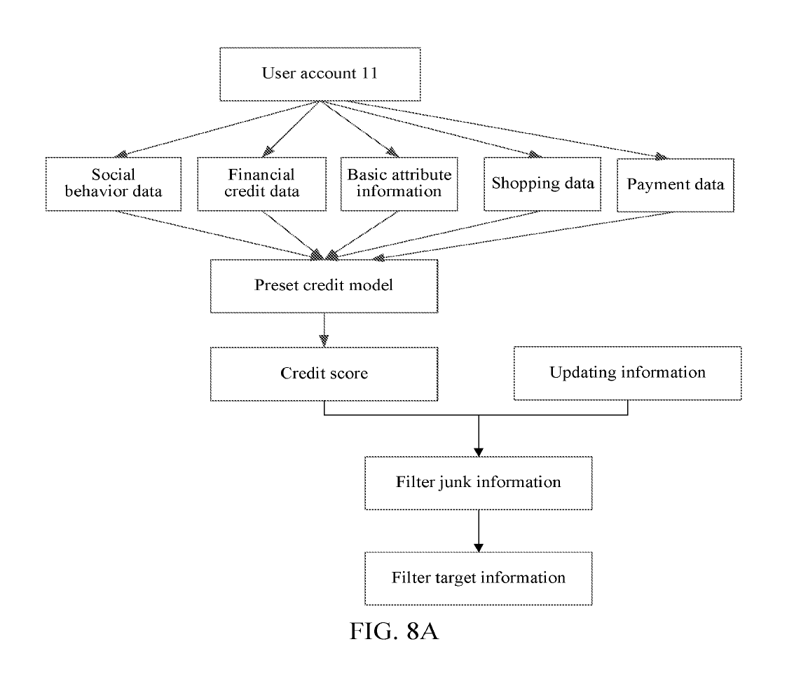

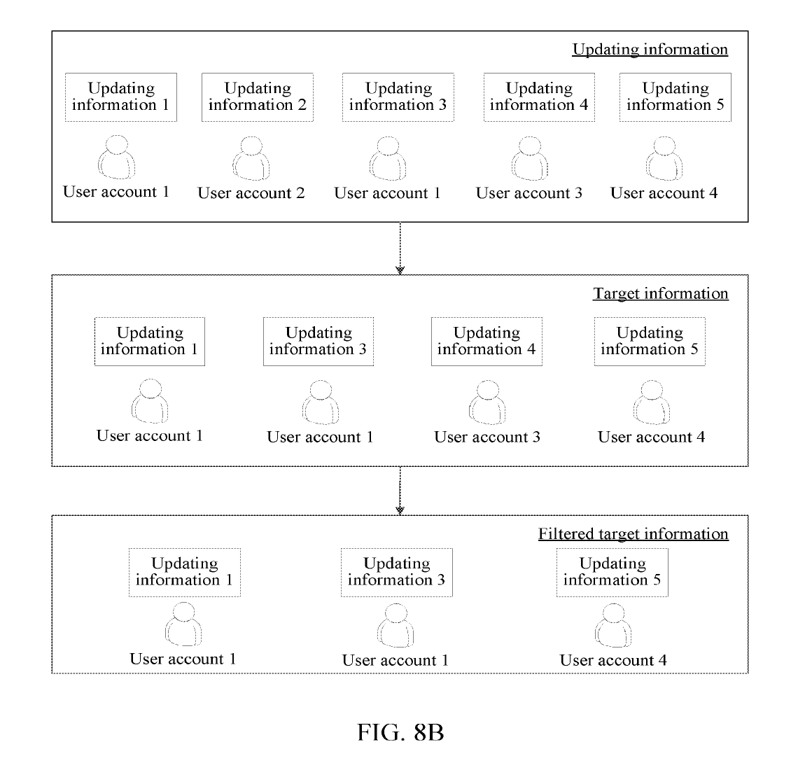

In an exemplary example, assuming that a user account 1, a user account 2, a user account 3, and a user account 4 are all user accounts in a friend relationship chain of a particular target user account, for any user account 11 in the user account 1, the user account 2, the user account 3, and the user account 4, the social application server pre-obtains social behavior data, financial credit data, basic attribute data, shopping data, payment data, and the like of the user account, and certainly may also obtain other online behavior data and offline behavior data, and input the obtained data into a preset credit model, to generate a credit score of the user account. Assuming that the social application server separately obtains updating information released by the user account 1, the user account 2, the user account 3, and the user account 4 when receiving an obtaining request sent by a target user account, the social application server filters junk information in all the obtained updating information according to a credit score of each user account, to obtain target information needing to be sent to the target user account, and filters the target information again when there is a relatively large amount of the target information. A schematic flowchart is shown in FIG. 8A.

As shown in FIG. 8B, assuming that the updating information obtained by the social application server includes updating information 1 released by the user account 1, updating information 2 released by the user account 2, updating information 3 released by the user account 1, updating information 4 released by the user account 3, and updating information 5 released by the user account 4, assuming that the credit score is a credit value, and the social application server obtains that a credit value of the user account 1 is 550, a credit value of the user account 2 is 200, a credit value of the user account 3 is 400, and a credit value of the user account 4 is 570, and assuming that the filter condition is a preset value threshold 350, the social application server determines that the credit value of the user account 2 is less than the preset value threshold 350, and filters the updating information 2.

In this case, the total number of pieces that is of target information sent to the target user account and that is determined by the social application server is four. Assuming that the threshold of the number of pieces is three, the social application server further obtains a matching value of each piece of updating information. Assuming that a matching value of the updating information 1 is 20, a matching value of the updating information 3 is 70, a matching value of the updating information 4 is 85, and a matching value of the updating information 5 is 60, and assuming that an interest index is a sum of a matching value and a credit value, the social application server finally determines that an interest index of the updating information 1 is 570, an interest index of the updating information 3 is 620, an interest index of the updating information 4 is 485, and an interest index of the updating information 5 is 630. Assuming that the second threshold is 500, the social application server filters the updating information 4 whose interest index is less than 500. Finally, the updating information 1, the updating information 3, and the updating information 5 are sent to the target user account.

Note that the embodiments shown in FIG. 3 to FIG. 6 are separately described by using a case in which one filter condition is included as an example. However, in actual implementation, the social application server may filter information according to any combination of the foregoing three filter conditions. Details are not described in this embodiment again.

Apparatus embodiments of this application are described below. Reference may be made to the foregoing method embodiments having one-to-one correspondence to the apparatus embodiments for details that are not described in detail in the apparatus embodiments.

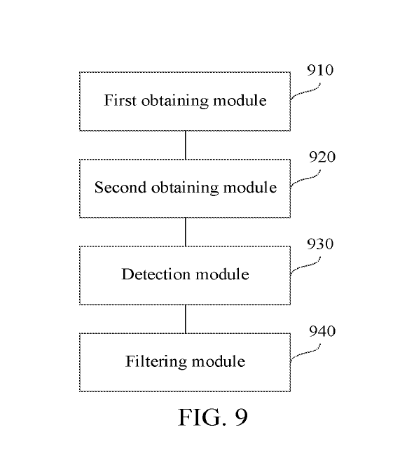

Referring to FIG. 9, FIG. 9 is a schematic structural diagram of an information filtering apparatus according to an embodiment of this application. The information filtering apparatus may be implemented as the social application server shown in FIG. 1 or FIG. 2 by means of software, hardware, or a combination thereof. The apparatus includes:

a first obtaining module 910, configured to perform step 301;

a second obtaining module 920, configured to perform step 302;

a detection module 930, configured to perform step 303; and

a filtering module 940, configured to perform step 304, step 403, and step 506.

Optionally, the detection module 930 includes:

a first detection unit, configured to perform step 401; and

a first determining unit, configured to perform step 402.

Optionally, the detection module 930 includes:

a second determining unit, configured to perform step 501, step 502, and step 503;

a third determining unit, configured to perform step 601, step 602, and step 603;

a second detection unit, configured to perform step 504; and

a fourth determining unit, configured to perform step 505.

Optionally, the second determining unit includes:

a first calculation subunit, configured to perform step 501; and

a first determining subunit, configured to perform step 502.

Optionally, the second determining unit includes:

a second calculation subunit, configured to perform step 601;

a second determining subunit, configured to perform step 602; and

a third determining subunit, configured to perform step 603.

Optionally, the apparatus further includes:

a first determining module, configured to perform step 701;

a piece number detection module, configured to perform step 702;

a second determining module, configured to perform step 703;

an interest detection module, configured to perform step 704; and

a target information filtering module, configured to perform step 705.

Based on the above, the information filtering apparatus provided in this embodiment of this application obtains updating information, detects whether the updating information meets a filter condition according to a credit score of a user account that releases the updating information, and filters the updating information when the updating information meets the filter condition, so that the problem that is of incomplete filtering on junk information and that is caused by limited key words when information filtering is performed by means of key word matching is resolved. Usually, the probability of releasing junk information by a user account having relatively high credit is relatively low, and the probability of releasing junk information by a user account having relatively low credit is relatively high. Therefore, filtering updating information released by a user account according to a credit score of the user account makes filtering on junk information more complete.

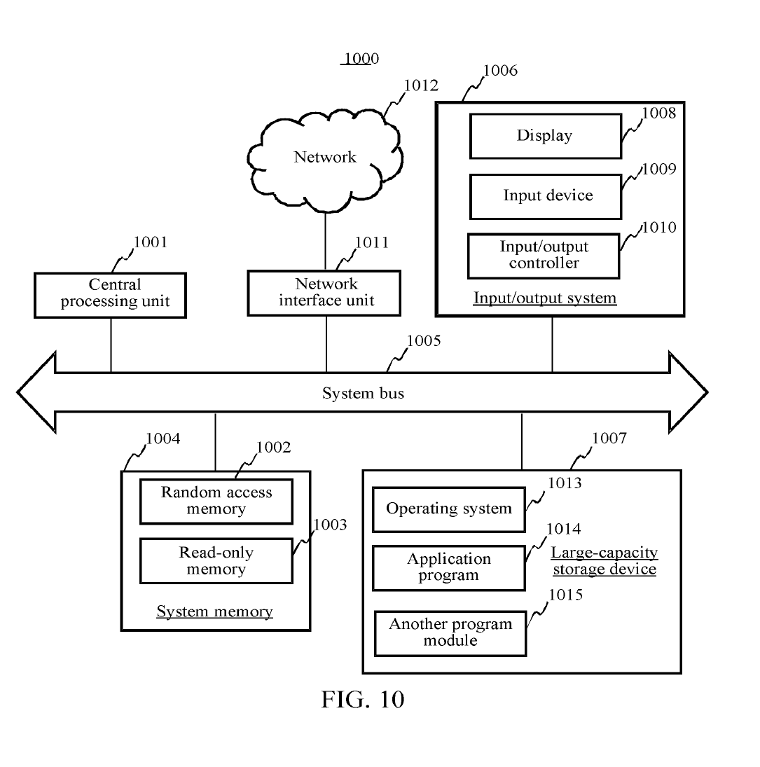

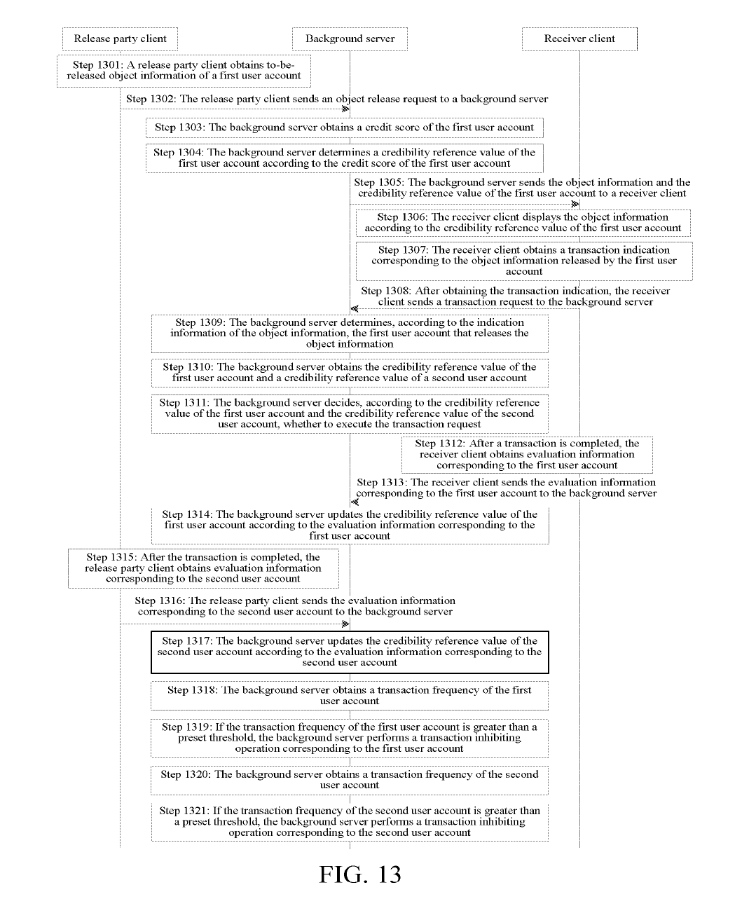

Referring to FIG. 10, FIG. 10 is a structural block diagram of a server according to an embodiment of this application. The server may be the social application server in FIG. 1 or FIG. 2, or a subsequent server applied to transaction control in the FIG. 12 or FIG. 13. Specifically, the server 1000 includes a central processing unit (CPU) 1001, a system memory 1004 including a random access memory (RAM) 1002 and a read-only memory (ROM) 1003, and a system bus 1005 connected to the system memory 1004 and the CPU 1001. The server 1000 further includes a basic input/output system (I/O system) 1006 helping information transmission between various devices in a computer, and a large-capacity storage device 1007 configured to store an operating system 1013, an application program 1014, and another program module 1015.

The basic I/O system 1006 includes a display 1008 configured to display information and an input device 1009 configured to enter information by a user, for example, a mouse or a keyboard. The display 1008 and the input device 1009 are both connected to the CPU 1001 by using an input and output controller 1010 connected to the system bus 1005. The basic I/O system 1006 may further include the input and output controller 1010 for receiving and processing inputs from a plurality of other devices such as a keyboard, a mouse, or an electronic stylus. Similarly, the input and output controller 1010 further provides an output to a display screen, a printer or another type of output device.

The large-capacity storage device 1007 is connected to the CPU 1001 by using a large-capacity storage controller (not shown) connected to the system bus 1005. The large-capacity storage device 1007 and a computer readable medium associated with the large-capacity storage device 1007 provide non-volatile storage for the server 1000. That is, the large-capacity storage device 1007 may include a computer readable medium (not shown) such as a hard disk or a CD-ROM drive.

Without loss of generality, the computer readable medium may include a computer storage medium and a communications medium. The computer storage medium includes volatile and non-volatile, movable and unmovable media implemented by using any method or technology and configured to store information such as a computer readable instruction, a data structure, a program module, or other data. The computer storage medium includes a RAM, a ROM, an EPROM, an EEPROM, a flash memory, or another solid storage technology, and a CD-ROM, a DVD, or another optical storage, and a cassette, a tape, magnetic storage, or another magnetic storage device. Certainly, a person skilled in the art may know that the computer storage medium is not limited to the foregoing. The system memory 1004 and the large-capacity storage device 1007 may be uniformly referred to as a memory.

According to the various embodiments of this application, the server 1000 may run by connecting to a remote computer on a network by using a network such as Internet. That is, the server 1000 may be connected to a network 1012 by using a network interface unit 1011 connected to the system bus 1005, or the server 1000 may be connected to a network of another type or a remote computer system (not shown) by using a network interface unit 1011.

The memory further includes one or more programs. The one or more programs are stored in the memory. In an example, the one or more programs include a program for performing the information filtering method provided in the embodiments of this application.

Note that when the information filtering apparatus provided in the foregoing embodiment filters information, the foregoing functional modules are described for exemplary purposes. In actual applications, the functions may be allocated to different functional modules according to requirements. That is, the internal structure of the server is divided into different functional modules to complete all or some of the functions described above. In addition, the information filtering apparatus provided in the foregoing embodiment is based on the same idea as the embodiment of the information filtering method. For the specific implementation process, refer to the method embodiment, and the details are not described herein again.

This application further provides a computer readable storage medium, which stores one or more programs. The one or more programs are loaded and executed by a processor, to implement the information filtering method executed on the side of the social application server.

In a possible implementation, the computer readable storage medium further stores a program for implementing the following method:

detecting whether the credit score is less than a preset indicator; and

when the credibility score is less than the preset indicator, determining that the updating information meets the filter condition.

In a possible implementation, the computer readable storage medium further stores a program for implementing the following method:

determining first quality information of the updating information according to the updating information, and determining a sending index of the updating information according to the credit score and the first quality information, where the sending index is in a positive correlation with the credit score and the first quality information;

detecting whether the sending index is less than a first threshold; and

when the sending index is less than the first threshold, determining that the updating information meets the filter condition.

In a possible implementation, the computer readable storage medium further stores a program for implementing the following method:

determining second quality information according to the updating information and each piece of updating information released by the user account in a preset time period, and determining the sending index of the updating information according to the credit score and the second quality information, where the sending index is in a positive correlation with the credit score and the second quality information;

detecting whether the sending index is less than a first threshold; and

when the sending index is less than the first threshold, determining that the updating information meets the filter condition.

In a possible implementation, the computer readable storage medium further stores a program for implementing the following method:

determining a total number N of pieces of target information, where the target information is updating information, which does not meet the filter condition, in updating information sent to a target user account, and the target user account is a user account used to display the updating information;

detecting whether the total number N of pieces is greater than a threshold of the number of pieces;

when the total number N of pieces is greater than the threshold of the number of pieces, obtaining interest information of the target user account, and for each piece of the target information, determining an interest index of the target information according to the interest information and a credit score of a user account that releases the target information, where the interest index is used to represent a degree of interest of a user of the target user account on the target information;

detecting whether the interest index is less than a second threshold; and

when the interest index is less than the second threshold, filtering the target information sent to the target user account.

With the development of Internet technologies, network transaction of a plurality of forms occurs, such as network shopping, object exchange, and the like. In the related technology, after obtaining object information released by an object release party, a network transaction platform sends the object information to a receiver client. The receiver client receives and displays the object information. According to the object information, a user may select and confirm whether to perform transaction. Lack of mutual understanding of both parties of transaction causes lack of confidence of the security of the transaction. Therefore, transaction control may also be performed based on a credit score. Whether to execute a transaction request is decided by obtaining credibility reference values of transaction parties, so that the problem in the related technology that the security of the transaction cannot be ensured and that is caused by lack of mutual understanding of the both parties of the transaction is resolved. Because the transaction credibility of the both parties of the transaction are considered, deciding whether to execute a transaction request on such basis facilitates improving the security of the transaction.

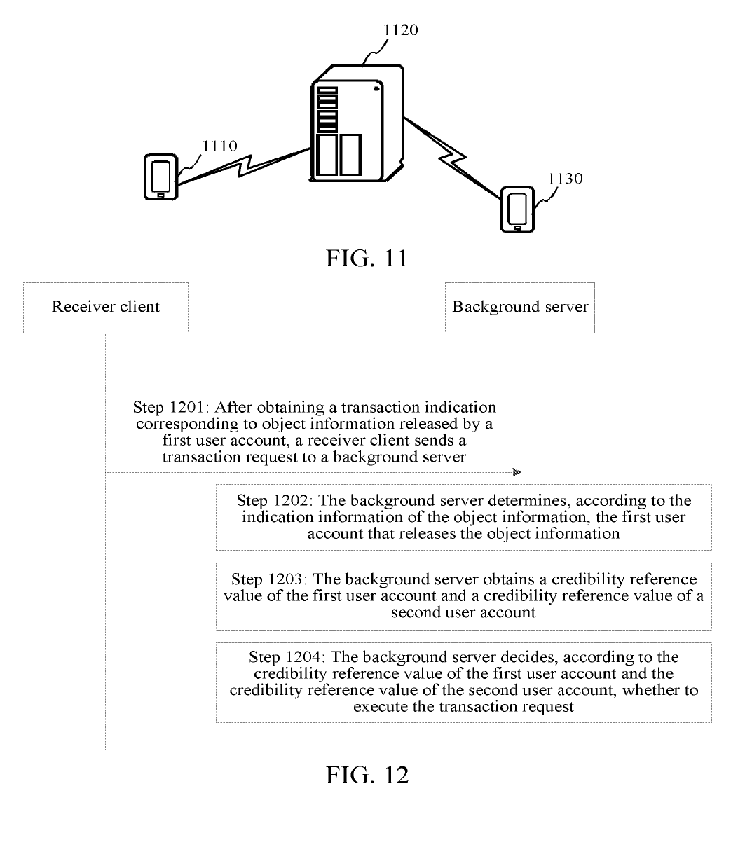

Referring to FIG. 11, FIG. 11 is a schematic diagram of an implementation environment according to an embodiment of this application. The implementation environment includes: a release part terminal 1110, a background server 1120, and a receiver terminal 1130.

The release party terminal 1110 may be an electronic device such as a mobile phone, a tablet computer, a personal digital assistant (PDA), or a personal computer (PC). A release party client is installed and runs in the release party terminal 1110. The release party client is a client application program having an object transaction function of the side of the release party client involved in this embodiment of this application. For example, the application program may be an object-object exchange application, a network shopping application, a life service application, or the like.

The background server 1120 separately establishes a communications connection to the release party terminal 1110 and the receiver terminal 1130 by using a network. For example, the network may be a wireless network, or a wired network. The background server 1120 may be a server, a server cluster composed of several servers, or a cloud computing service center.

The receiver terminal 1130 may be an electronic device such as a mobile phone, a tablet computer, a PDA, or a PC. A receiver client is installed and runs in the receiver terminal 1130. The receiver client is a client application program having an object transaction function of the side of the receiver client involved in this embodiment of this application. For example, the application program may be an object-object exchange application, a network shopping application, a life service application, or the like.

In actual application, the release party client and the receiver client may be two different clients. One client has the function of the side of the release party client, and the other client has the function of the side of the receiver client. Alternatively, the release party client and the receiver client may also be two same clients. The client not only has the function of the side of the release party client, but also has the function of the side of the receiver client.

As one type of released information, object information may also be processed differently based on a credibility reference value. Referring to FIG. 12, FIG. 12 is a flowchart of a transaction control method according to an embodiment of this application. The method may be applied to the implementation environment shown in FIG. 11. The method may include the following steps.

Step 1201: After obtaining a transaction indication corresponding to object information released by a first user account, a receiver client sends a transaction request to a background server, the transaction request carrying a second user account that logs in to the receiver client and indication information of the object information.

Correspondingly, the background server receives the transaction request sent by the receiver client.

Step 1202: The background server determines, according to the indication information of the object information, the first user account that releases the object information.

Step 1203: The background server obtains a credibility reference value of the first user account and a credibility reference value of the second user account, the credibility reference value being used to indicate transaction credibility of a user account.

Step 1204: The background server decides, according to the credibility reference value of the first user account and the credibility reference value of the second user account, whether to execute the transaction request.

Based on the above, according to the method provided in this embodiment, after receiving a transaction request sent by a receiver client, a background server obtains a credibility reference value of a first user account and a credibility reference value of a second user account, and decides, according to the credibility reference values of both parties of the transaction, whether to execute the transaction request, so that the problem in the related technology that the security of the transaction cannot be ensured and that is caused by lack of mutual understanding of the both parties of the transaction is resolved. Because the transaction credibility of the both parties of the transaction are considered, deciding whether to execute a transaction request on such basis facilitates improving the security of the transaction.

Referring to FIG. 13, FIG. 13 is a flowchart of a transaction control method according to another embodiment of this application. The method may be applied to the implementation environment shown in FIG. 11. The method may include the following steps.

Step 1301: A release party client obtains to-be-released object information of a first user account.

The first user account is a user account that logs in to the release party client. In an example, when a user needs to release object information, the release party client displays a basic information form, and the user fills the to-be-released object information into the basic information form. Correspondingly, the release party client obtains the to-be-released object information filled into the basic information form by the first user account.

In this embodiment of this application, the object information is information of a to-be-transacted object, and includes but is not limited to any one of the following: information of a to-be-exchanged-out object, information of a to-be-exchanged-in object, information of a to-be-sold object, and information of a to-be-purchased object. For example, when the release party client is a client of an object-object exchange application, the object information may be information of a to-be-exchanged-out object or information of a to-be-exchanged-in object. The information of the to-be-exchanged-out object may include: a name, a category, a description, a picture, newness, and the like of the to-be-exchanged-out object. The information of the to-be-exchanged-in object may include: a name, a category, a description, expected newness, and the like of the to-be-exchanged-in object. For another example, when the release party client is a client of a shopping application, the object information may be information of a to-be-sold object or information of a to-be-purchased object. The information of the to-be-sold object may include: a name, a category, a description, a picture, a price, newness, and the like of the to-be-sold object. The information of the to-be-purchased object may include: a name, a category, a description, an expected price, expected newness, and the like of the to-be-purchased object.

Step 1302: The release party client sends an object release request to a background server.

The object release request includes the first user account that logs in to the release party client and the object information.

Correspondingly, the background server receives the object release request sent by the release party client.

Optionally, before sending the object release request to the background server, the release party client may further perform the following steps: obtaining user identity information bound to the first user account; verifying the user identity information; if the verification on the user identity information succeeds, performing step 302; and otherwise, if the verification on the user identity information does not succeed, ending the flow. The user identity information is information used to reflect real identity of a user, including but not limited to at least one of the following: a mobile phone number, an identity card number, and bank card information. The foregoing manner facilitates improving the credibility of the object information that is successfully released.

Step 1303: The background server obtains a credit score of the first user account.

The credit score of the first user account is used to indicate a credit status of the first user account. Reference may be made to the foregoing text for introduction related to the credit score. Details are not described herein again.

In an example, the background server obtains the credit score of the first user account from a credit score library according to the first user account or the user identity information bound to the first user account. Credit scores of various users are pre-stored in the credit score library.

In another example, the background server obtains characteristic information of the first user account, and calculates the credit score of the first user account according to the characteristic information of the first user account. The characteristic information includes but is not limited to at least one of the following: social information, financial information, behavior information, and identity information. Reference may be made to the foregoing text for introduction related to the foregoing characteristic information. Details are not described herein again. In actual application, a credit score calculation model may be constructed by using a machine learning (ML) algorithm. An input parameter of the credit score calculation model is characteristic information of a user account, and an output result is a credit score of the user account. In this embodiment of this application, the specific type of the ML algorithm is not limited. For example, a regressive decision tree algorithm, a logistic regression algorithm, a random forests algorithm, a neural network algorithm, a deep learning algorithm or the like may be used. The credit score calculation model is trained by using a particular number of training samples, and then a corresponding credit score is predicted according to the characteristic information of the user account by using the model, training on which is completed.

Step 1304: The background server determines a credibility reference value of the first user account according to the credit score of the first user account.

The credibility reference value of the first user account is used to indicate a transaction credibility of the first user account. Reference may be made to the foregoing text for introduction related to the credibility reference value. Details are not described herein again.

In an example, the background server determines the credibility reference value of the first user account according to the credit score and reference information of the first user account. The reference information includes at least one of the following: historical transaction behavior data of the first user account and object information released by the first user account. For example, the background server uses the credit score of the first user account as a basic value of the credibility reference value, calculates a modified value of the credibility reference value according to the reference information, and then calculates the credibility reference value according to the basic value and the modified value. In actual application, a modified value calculation model may be constructed by using the ML algorithm. An input parameter of the modified value calculation model is reference information of a user account, and an output result is the modified value. In this embodiment of this application, the specific type of the ML algorithm is not limited. The modified value calculation model is trained by using a particular number of training samples, and then a corresponding modified value is predicted according to the reference information of the user account by using the model, training on which is completed. For example, the background server adds the basic value and the modified value, to obtain the credibility reference value. In the foregoing manner, the credibility reference value is calculated by combining the credit score and the reference information, so that the credibility reference value can be adjusted with the historical transaction behaviors of a user and/or object information released by the user, thereby more accurately reflecting the credibility of the object information currently released by the user.

Step 1305: The background server sends the object information and the credibility reference value of the first user account to a receiver client.

Correspondingly, the receiver client receives the object information and the credibility reference value of the first user account that are sent by the background server.

Step 1306: The receiver client displays the object information according to the credibility reference value of the first user account.

In an example, when displaying the object information released by the first user account, the receiver client displays the credibility reference value of the first user account. In the foregoing manner, a user is made to learn the transaction credibility of a release party of object information.

In another example, the receiver client determines a sort position of the object information according to the credibility reference value of the first user account. The priority of the sort position is in a positive correlation with the credibility reference value. The object information is displayed according to the sort position of the object information. For example, the receiver client displays each piece of object information in descending order of credibility reference values.

In another example, the receiver client detects whether a credibility reference value of the first user account is greater than a preset value. If the credibility reference value of the first user account is greater than the preset value, object information released by the first user account is displayed; and otherwise, if the credibility reference value of the first user account is less than the preset value, the object information released by the first user account is not displayed.

Optionally, the receiver client supports a classification display function and/or a search display function. The classification display function is to distinguish between object information of different categories, and display object information of a category selected by a user. The search display function is to display object information related to a key word according to the key word input by the user.

Step 1307: The receiver client obtains a transaction indication corresponding to the object information released by the first user account.

When a user decides to perform transaction with a release party of the object information after browsing the object information released by the first user account, the transaction indication corresponding to the object information may be triggered. Correspondingly, the receiver client obtains the transaction indication.

Step 1308: After obtaining the transaction indication, the receiver client sends a transaction request to the background server.

The transaction request carries a second user account that logs in to the receiver client and indication information of the object information. The indication information of the object information may be generated by the background server, and is sent together with the object information to the receiver client in step 305. The indication information of the object information is used to uniquely identify the object information, and indication information corresponding to different object information is also different.

Correspondingly, the background server receives the transaction request sent by the receiver client.

Step 1309: The background server determines, according to the indication information of the object information, the first user account that releases the object information.

The background server stores a correspondence between the object information released by the first user account, the first user account, and the indication information of the object information. After receiving the transaction request, the background server queries the correspondence, and obtains the first user account corresponding to the indication information of the object information.

Step 1310: The background server obtains the credibility reference value of the first user account and a credibility reference value of a second user account.

The credibility reference value of the second user account is used to indicate a transaction credibility of the second user account. The credibility reference value of the second user account may be determined by the background server according to a credit score of the second user account. The credit score of the second user account is used to indicate a credit status of the second user account. In an example, the background server determines the credibility reference value of the second user account according to the credit score of the second user account and historical transaction behavior data of the second user account. Certainly, if the credibility reference value of the second user account has been stored in the background server, the background server may directly obtain the credibility reference value.

The credibility reference value of the first user account is the credibility reference value determined by the background server in step 304.

Step 1311. The background server decides, according to the credibility reference value of the first user account and the credibility reference value of the second user account, whether to execute the transaction request.

Different from the related technology, in the related technology, if a demand side sends a transaction request, the background server does not control whether to execute the transaction request, instead, directly executes the transaction request. However, in this embodiment of this application, the background server controls whether to execute the transaction request. Specifically, the background server decides whether to execute the transaction request according to credibility reference values of both parties of a transaction.

In an example, this step includes the following several sub steps: if the credibility reference value of the first user account and the credibility reference value of the second user account are both greater than a preset threshold, determining, by the background server, to execute the transaction request; and if the credibility reference value of the first user account and/or the credibility reference value of the second user account are less than the preset threshold, determining, by the background server, not to execute the transaction request. If the credibility reference values of the both parties of the transaction are both greater than the preset threshold, it indicates that the transaction credibility of the both parties of the transaction are both relatively high, and the security risk existing in the transaction of this time is relatively low, and the transaction request of this time is allowed to be executed. If the credibility reference value of at least one of the both parties of the transaction is less than the preset threshold, it indicates that the transaction credibility of at least one of the both parties of the transaction is relatively low, and a relatively high security risk may exist in the transaction of this time. To improve the security of the transaction and guarantee benefits of the both parties of the transaction, the transaction request of this time is not allowed to be executed.

In addition, in actual implementation, preset thresholds set for the both parties of the transaction may be the same, or may be different.

Optionally, this embodiment further provides an updating mechanism of the credibility reference value. The method provided in this embodiment may further include the following step 1312 to step 1314 and/or step 1315 to step 1317.

Step 1312: After a transaction is completed, the receiver client obtains evaluation information corresponding to the first user account.

The evaluation information corresponding to the first user account is evaluation information made by a user corresponding to the second user account according to a result of the transaction of this time. For example, the evaluation information corresponding to the first user account may include: a matching degree between an object exchanged out/sold by the first user account and a description, evaluation on the object exchanged out/sold by the first user account, evaluation on the attitude and/or behavior of a user corresponding to the first user account in the process of the transaction, and the like.

Step 1313: The receiver client sends the evaluation information corresponding to the first user account to the background server.

Correspondingly, the background server receives the evaluation information that corresponds to the first user account and that is sent by the receiver client.

Step 1314: The background server updates the credibility reference value of the first user account according to the evaluation information corresponding to the first user account.

The principle of updating the credibility reference value according to the evaluation information corresponding to a user account is that: better evaluation indicated by the evaluation information indicates a larger credibility reference value; and otherwise, poorer evaluation indicated by the evaluation information indicates a smaller credibility reference value.

In actual application, an update value calculation model of the credibility reference value may be constructed by using an ML algorithm. An input parameter of the update value calculation model is evaluation information corresponding to a user account, and an output result is an update value of the credibility reference value. In this embodiment of this application, the specific type of the ML algorithm is not limited. The update value calculation model is trained by using a particular number of training samples, and then a corresponding update value is predicted according to the evaluation information corresponding to the user account by using the model, training on which is completed. For example, the background server adds the credibility reference value before update and the update value, to obtain an updated credibility reference value.

Step 1315: After the transaction is completed, the release party client obtains evaluation information corresponding to the second user account.

The evaluation information corresponding to the second user account is evaluation information made by the user corresponding to the first user account according to the result of the transaction of this time. For example, the evaluation information corresponding to the second user account may include: a matching degree between an object exchanged out/sold by the second user account and a description, evaluation on the object exchanged out/sold by the second user account, evaluation on the attitude and/or behavior of the user corresponding to the second user account in the process of the transaction, and the like.

Step 1316: The release party client sends the evaluation information corresponding to the second user account to the background server.

Correspondingly, the background server receives the evaluation information that corresponds to the second user account and that is sent by the release party client.

Step 1317: The background server updates the credibility reference value of the second user account according to the evaluation information corresponding to the second user account.

By using the updating mechanism of the credibility reference value, the credibility reference value of a user account is updated in real time with transaction behaviors of a user, so that the accuracy of the credibility reference value is ensured, thereby facilitating improving the reference value thereof.

Optionally, this embodiment further provides a transaction inhibiting mechanism. The method provided in this embodiment further includes the following step 1318 to step 1319 and/or step 1320 to step 1321.

Step 1318: The background server obtains a transaction frequency of the first user account.

The transaction frequency of a user account is the number of times of transaction of the user account per unit time.

Step 1319: If the transaction frequency of the first user account is greater than a preset threshold, the background server performs a transaction inhibiting operation corresponding to the first user account.

The transaction inhibiting operation is a control operation for inhibiting a successful transaction. For example, the transaction inhibiting operation may include: reducing a credibility reference value, limiting a transaction, and the like.

Step 1320: The background server obtains a transaction frequency of the second user account.

Step 1321: If the transaction frequency of the second user account is greater than a preset threshold, the background server performs a transaction inhibiting operation corresponding to the second user account.

By using the transaction inhibiting mechanism, scalping behaviors can be effectively prevented, thereby maintaining a good transaction order.

Based on the above, according to the method provided in this embodiment, after receiving a transaction request sent by a receiver client, a background server obtains a credibility reference value of a first user account and a credibility reference value of a second user account, and decides, according to the credibility reference values of both parties of the transaction, whether to execute the transaction request, so that the problem in the related technology that the security of the transaction cannot be ensured and that is caused by lack of mutual understanding of the both parties of the transaction is resolved. Because the transaction credibility of the both parties of the transaction are considered, deciding whether to execute a transaction request on such basis facilitates improving the security of the transaction.

In addition, the credibility reference value is calculated by combining the credit score and the reference information, so that the credibility reference value can be adjusted with the historical transaction behaviors of a user and/or object information released by the user, thereby more accurately reflecting the credibility of the object information currently released by the user.

In addition, the receiver client further displays, according to the credibility reference value of the first user account, object information released by the first user account. For example, the receiver client displays each piece of object information in descending order of credibility reference values, so that a user can make a preferred choice by using the credibility reference value of the release party as reference when browsing the object information.

Note that in the foregoing embodiment, the steps related to the release party client may be implemented alone as a transaction control method of the side of the release party client, steps related to the receiver client may be implemented alone as a transaction control method of the side of the receiver client, and steps related to the background server may be implemented alone as a transaction control method of the side of the background server.

Apparatus embodiments of this application are described below, and may be used to execute the method embodiments of this application. Refer to the method embodiments of this application for details that are not disclosed in the apparatus embodiments of this application.

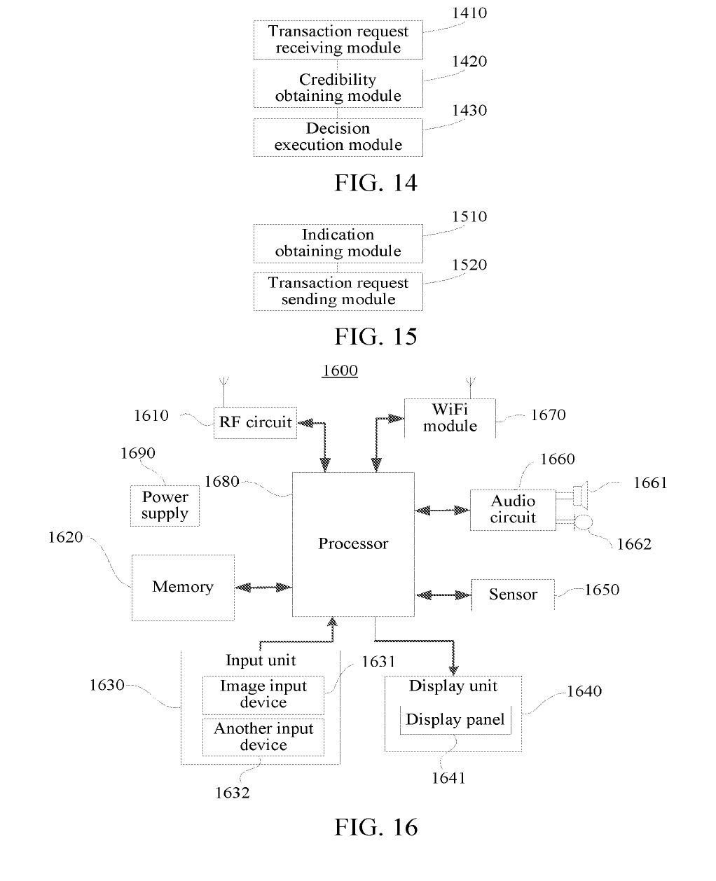

Referring to FIG. 14, FIG. 14 is a block diagram of a transaction control apparatus according to an embodiment of this application. The apparatus may implement functions of a background server in the foregoing method example. The functions may be implemented by hardware, or may be implemented by hardware executing corresponding software. The apparatus may include: a transaction request receiving module 1410, a credibility obtaining module 1420, and a decision execution module 1430.

The transaction request receiving module 1410 is configured to receive a transaction request that corresponds to object information and that is sent by a second user account.

The credibility obtaining module 1420 is configured to perform step 1203 or step 1310.

The decision execution module 1430 is configured to perform step 1204 or step 1311.

Optionally, the apparatus further includes: a release request receiving module, a score obtaining module, a credibility determining module, and an information sending module.

The release request receiving module is configured to receive an object release request sent by a release party client.

The score obtaining module is configured to perform step 1303.

The credibility determining module is configured to perform step 1304.

The information sending module is configured to perform step 1305.

Optionally, the credibility determining module is configured to determine the credibility reference value of the first user account according to a credit score and reference information of the first user account.

Optionally, the decision execution module is configured to: if the credibility reference value of the first user account and a credibility reference value of a second user account are both greater than a preset threshold, determine to execute a transaction request; and if the credibility reference value of the first user account and/or the credibility reference value of the second user account are less than the preset threshold, determine not to execute the transaction request.

Optionally, the apparatus further includes: a credibility updating module. The credibility updating module is configured to: after a transaction is completed, receive evaluation information that corresponds to the first user account and that is sent by the second user account, and perform step 1314; and/or, after the transaction is completed, receive evaluation information that corresponds to the second user account and that is sent by the first user account, and perform step 1317.

Optionally, the apparatus further includes: a transaction inhibiting module, configured to: perform step 1318 to step 1319; and/or, perform step 1320 to step 1321.

Reference may be made to the method embodiment shown in FIG. 12 or FIG. 13 for related details.

Referring to FIG. 15, FIG. 15 is a block diagram of a transaction control apparatus according to another embodiment of this application. The apparatus may implement functions of the side of a receiver client in the foregoing method example. The functions may be implemented by hardware, or may be implemented by hardware executing corresponding software. The apparatus may include: an indication obtaining module 1510 and a transaction request sending module 1520.

The indication obtaining module 1510 is configured to perform step 1307.

The transaction request sending module 1520 is configured to perform step 1308.

Optionally, the apparatus further includes: an information receiving module and an information display module.

The information receiving module is configured to receive object information and a credibility reference value of a first user account that are sent by a background server.

The information display module is configured to perform step 1306.

Optionally, the information display module is configured to: determine a sort position of the object information according to the credibility reference value of the first user account. The priority of the sort position is in a positive correlation with the credibility reference value. The object information is displayed according to the sort position of the object information.

Optionally, the apparatus further includes: an evaluation obtaining module and an evaluation sending module.

The evaluation obtaining module is configured to perform step 1312.

The evaluation sending module is configured to perform step 1313.

Reference may be made to the method embodiment shown in FIG. 12 or FIG. 13 for related details.

Note that when the apparatus provided in the foregoing embodiment implements the function thereof, the foregoing functional modules are described for exemplary purposes. In actual applications, the functions may be allocated to different functional modules according to requirements. That is, the internal structure of a device is divided into different functional modules to complete all or some of the functions described above. In addition, the apparatus embodiment provided in the foregoing embodiment is based on the same idea as the method embodiment. For the specific implementation process, refer to the method embodiment, and the details are not described herein again.

Referring to FIG. 16, FIG. 16 is a schematic structural diagram of a terminal according to an embodiment of this application. The terminal is configured to perform the transaction control method that is of the side of the client and that is provided in the foregoing embodiment. Specifically:

The terminal 1600 may include components such as a radio frequency (RF) circuit 1610, a memory 1620 including one or more computer readable storage media, an input unit 1630, a display unit 1640, a sensor 1650, an audio circuit 1660, a WiFi module 1670, a processor 1680 including one or more processing cores, and a power supply 1690. A person skilled in the art may understand that the structure of the terminal shown in FIG. 16 does not constitute a limitation to the terminal, and the terminal may include more components or fewer components than those shown in the figure, or some components may be combined, or a different component deployment may be used.

The RF circuit 1610 may be configured to receive and send signals during an information receiving and sending process or a call process. Particularly, the RF circuit 1610 receives downlink information from a base station, then delivers the downlink information to one or more processors 1680 for processing, and sends related uplink data to the base station. Generally, the RF circuit 1610 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 1610 may also communicate with a network and another device by wireless communication. The wireless communication may use any communication standard or protocol, including but not limited to Global System for Mobile communication (GSM), General Packet Radio Service (GPRS), Code Division Multiple Access (CDMA), Wideband Code Division Multiple Access (WCDMA), Long Term Evolution (LTE), email, and Short Messaging Service (SMS).

The memory 1620 may be configured to store a software program and module. The processor 1680 runs the software program and module stored in the memory 1620, to implement various functional applications and data processing. The memory 1620 may mainly include a program storage area and a data storage area. The program storage area may store an operating system, an application program used by at least one function (such as a sound playback function and an image display function), and the like. The data storage area may store data (such as audio data and an address book) created according to use of the terminal 1600, and the like. In addition, the memory 1620 may include a high speed random access memory, and may also include a non-volatile memory, such as at least one magnetic disk storage device, a flash memory, or another volatile solid-state storage device. Correspondingly, the memory 1620 may further include a memory controller, to provide access of the processor 1680 and the input unit 1630 to the memory 1620.

The input unit 1630 may be configured to receive input digit or character information, and generate a keyboard, mouse, joystick, optical, or track ball signal input related to the user setting and function control. Specifically, the input unit 1630 may include an image input device 1631 and another input device 1632. The image input device 1631 may be a camera, or a photoelectric scanning device. In addition to the image input device 1631, the input unit 1630 may further include another input device 1632. Specifically, the another input device 1632 may include, but is not limited to: one or more of a physical keyboard, a functional key (such as a volume control key or a switch key), a track ball, a mouse, and a joystick.

The display unit 1640 may be configured to display information input by the user or information provided for the user, and various graphical user interfaces of the terminal 1600. The graphical user interfaces may be composed of graphics, text, icons, videos, and any combination thereof. The display unit 1640 may include a display panel 1641. Optionally, the display panel 1641 may be configured in the form of a liquid crystal display (LCD), an organic light-emitting diode (OLED), or the like. The terminal 1600 may further include at least one sensor 1650 such as an optical sensor, a motion sensor, and other sensors. Specifically, the optical sensor may include an ambient light sensor and a proximity sensor. The ambient light sensor may adjust luminance of the display panel 1641 according to brightness of the ambient light. The proximity sensor may switch off the display panel 1641 and/or backlight when the terminal 1600 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors such as a gyroscope, a barometer, a hygrometer, a thermometer, and an infrared sensor, which may be configured in the terminal 1600, are not described in detail herein.

The audio circuit 1660, a speaker 1661, and a microphone 1662 may provide audio interfaces between the user and the terminal 1600. The audio circuit 1660 may convert received audio data into an electric signal and transmit the electric signal to the speaker 1661. The speaker 1661 converts the electric signal into a sound signal for output. On the other hand, the microphone 1662 converts a collected sound signal into an electric signal. The audio circuit 1660 receives the electric signal and converts the electric signal into audio data, and outputs the audio data to the processor 1680 for processing. Then, the processor 1680 sends the audio data to, for example, another terminal by using the RF circuit 1610, or outputs the audio data to the memory 1620 for further processing. The audio circuit 1660 may further include an earplug jack, to provide communication between a peripheral earphone and the terminal 1600.

WiFi is a short distance wireless transmission technology. In an example, a WiFi module 1670 is used. The terminal 1600 may help, by using the WiFi module 1670, the user to receive and send emails, browse a web page, access streaming media, and so on, which provides wireless broadband Internet access for the user. In an example, the WiFi module 1670 may be omitted.

The processor 1680 is a control center of the terminal 1600, which is connected to various parts of the entire mobile phone by using various interfaces and lines, and by running or executing a software program and/or module stored in the memory 1620 and calling data stored in the memory 1620, to perform various functions of the terminal 1600 and process data, so as to perform overall monitoring on the mobile phone. Optionally, the processor 1680 may include one or more processing cores. In an example, the processor 1680 may integrate an application processor and a modem. The application processor mainly processes an operating system, a user interface, an application program, and the like. The modem mainly processes wireless communication. It may be understood that the foregoing modem processor may alternatively not be integrated into the processor 1680.

The terminal 1600 further includes the power supply 1690 (such as a battery) for supplying power to the components. In an example, the power supply may be logically connected to the processor 1680 by using a power management system, thereby implementing functions such as charging, discharging, and power consumption management by using the power management system. The power supply 1690 may further include one or more of a direct current or alternating current power supply, a re-charging system, a power failure detection circuit, a power supply converter or inverter, a power supply state indicator, and any other component.

Although not shown in the figure, the terminal 1600 may further include a Bluetooth module and the like, which are not further described herein.

Specifically, in this embodiment, the terminal 1600 further includes a memory and one or more programs. The one or more programs are stored in the memory and configured to be executed by one or more processors. The one or more programs include instructions for performing the steps on the side of the client in the foregoing method example.

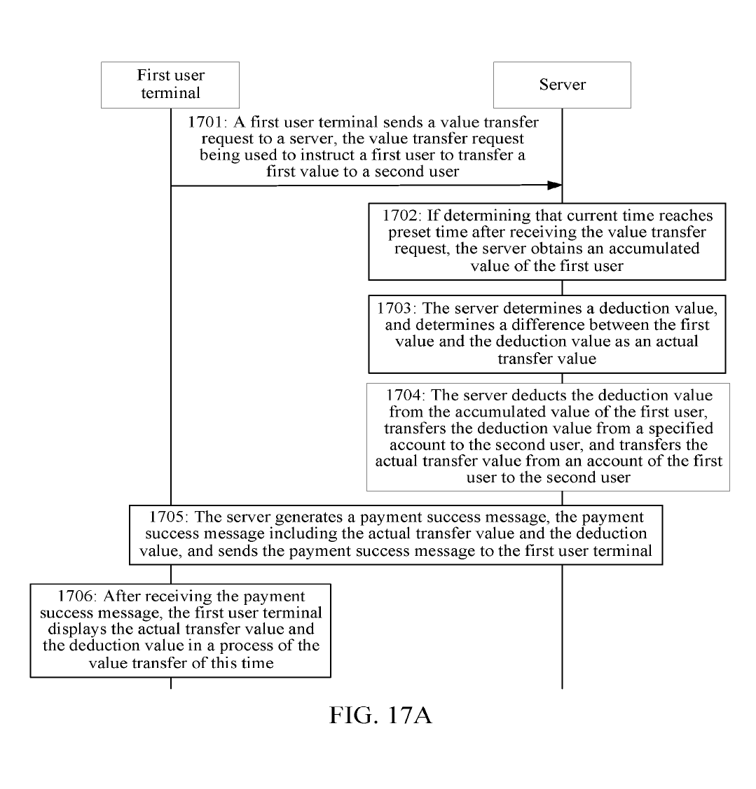

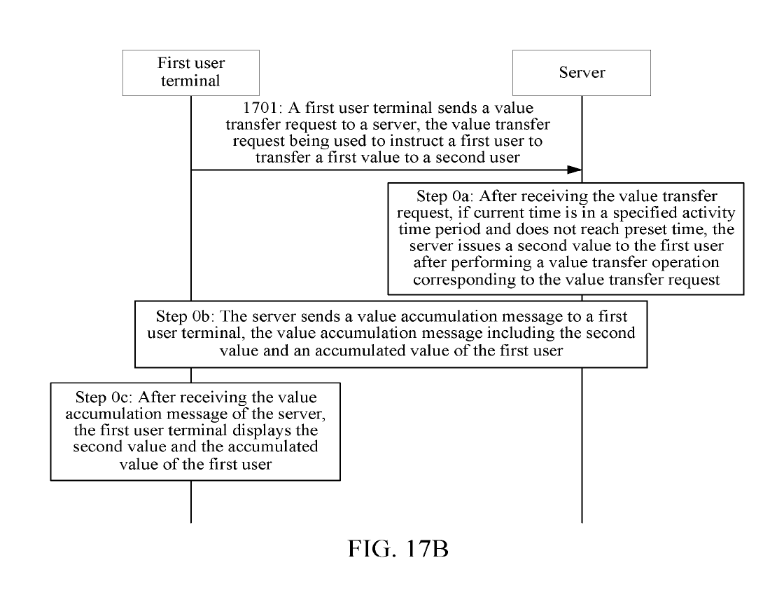

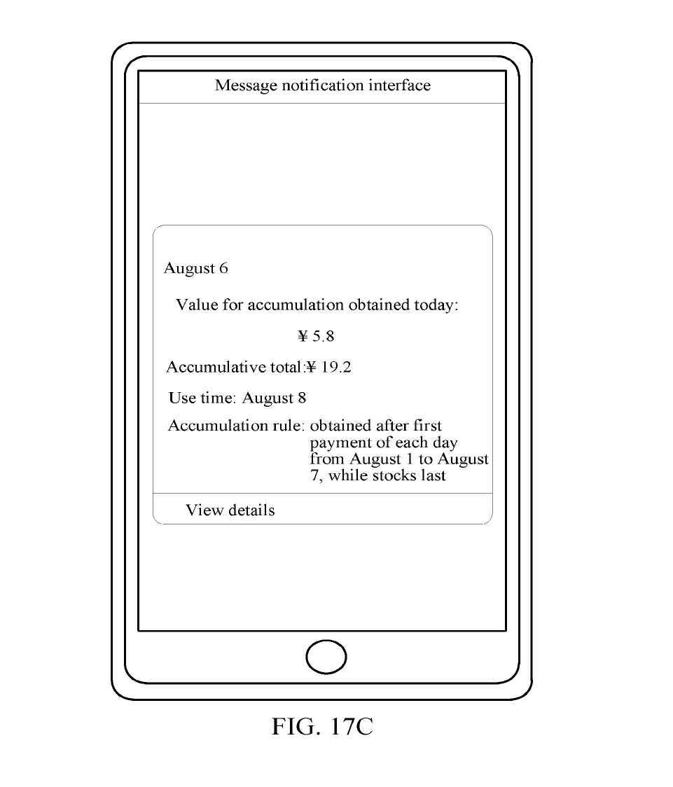

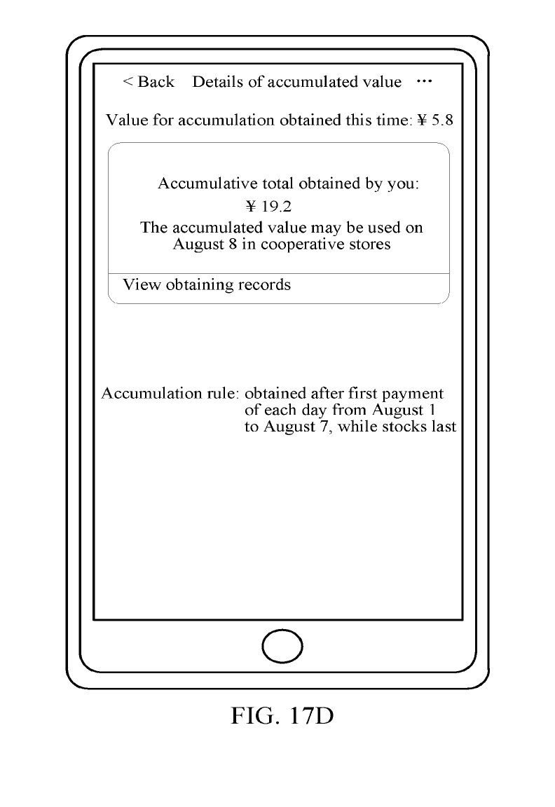

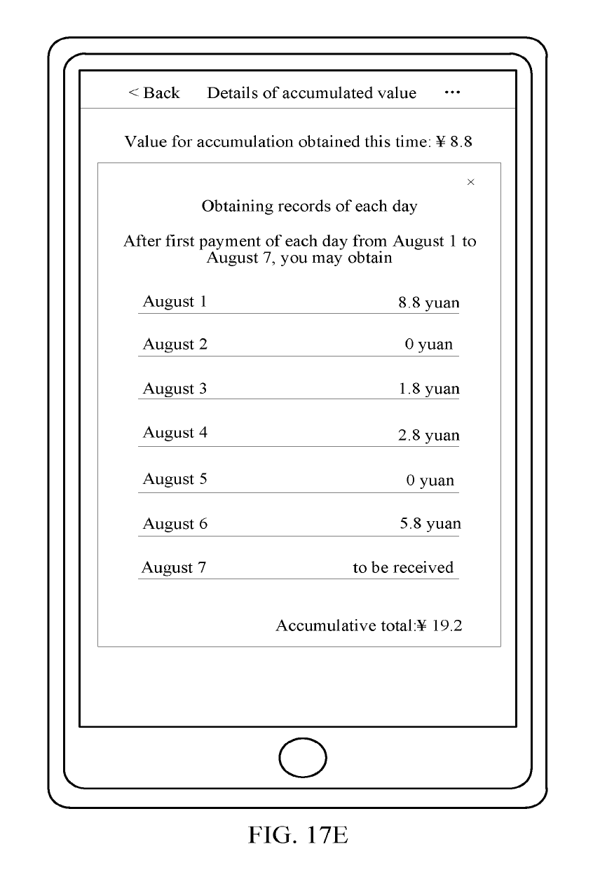

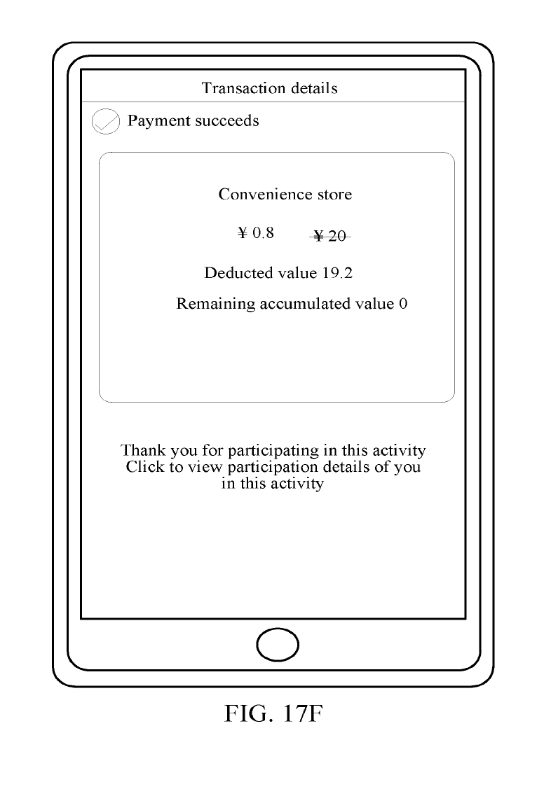

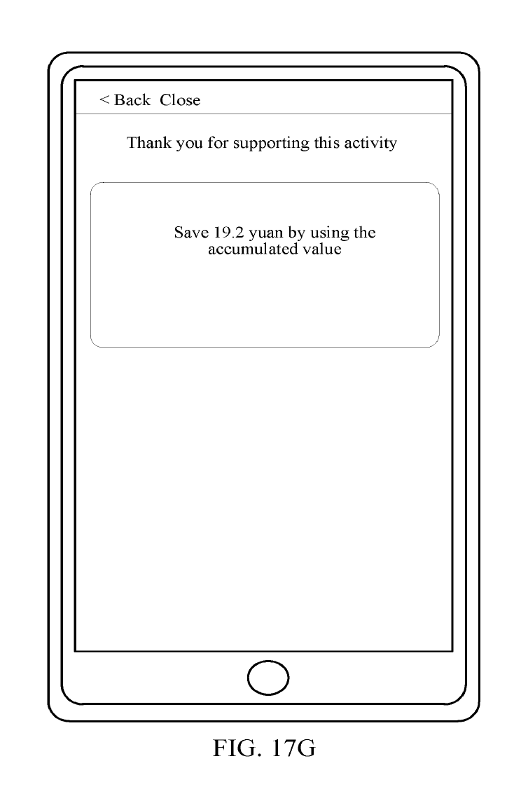

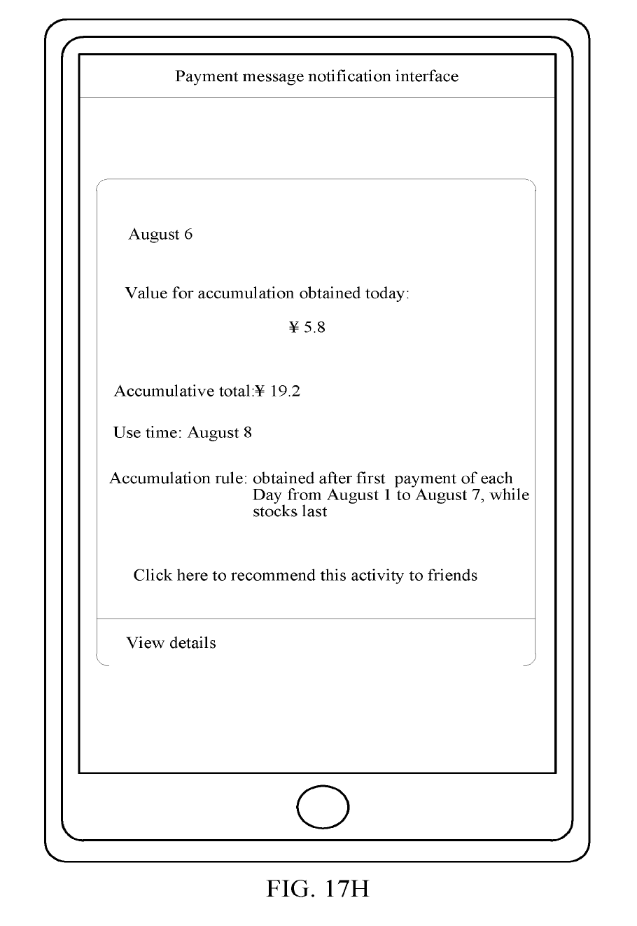

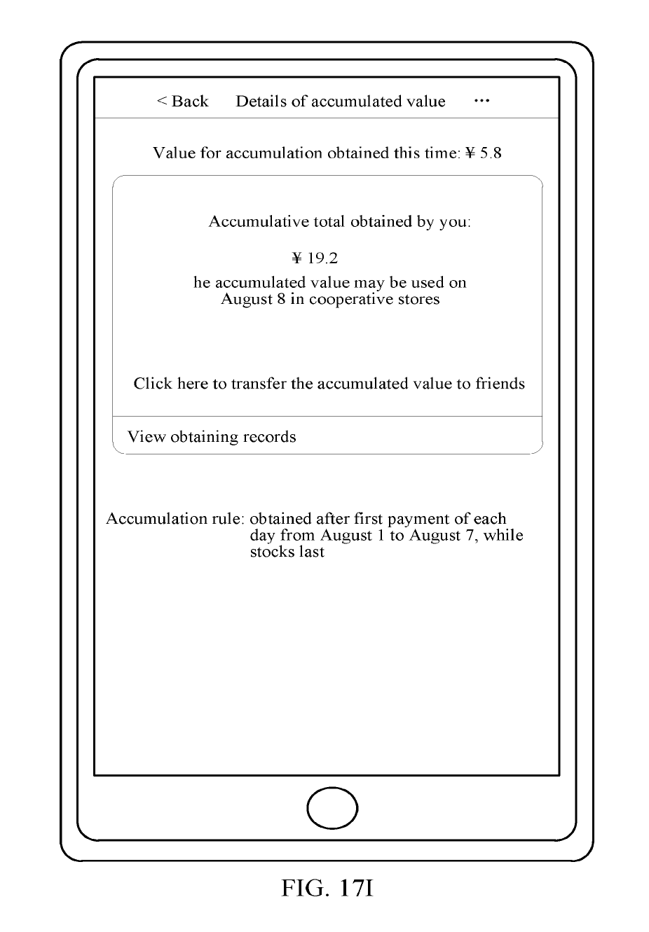

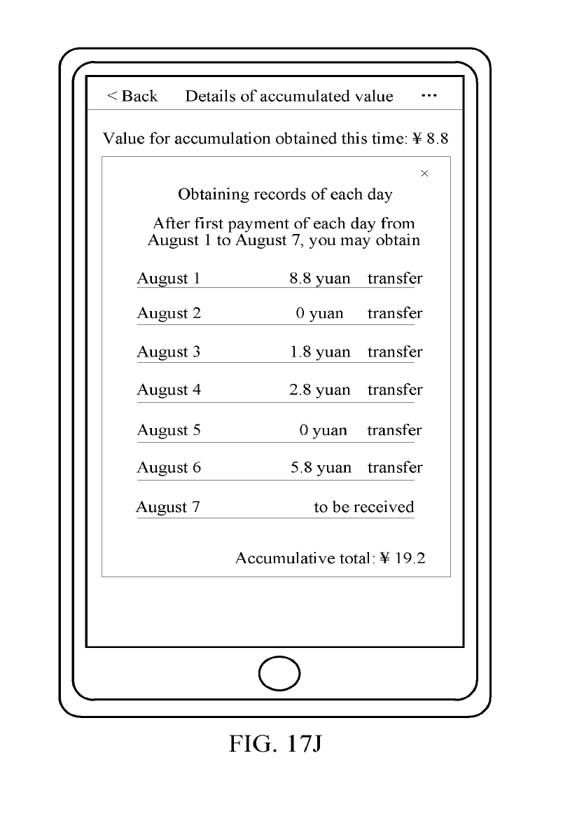

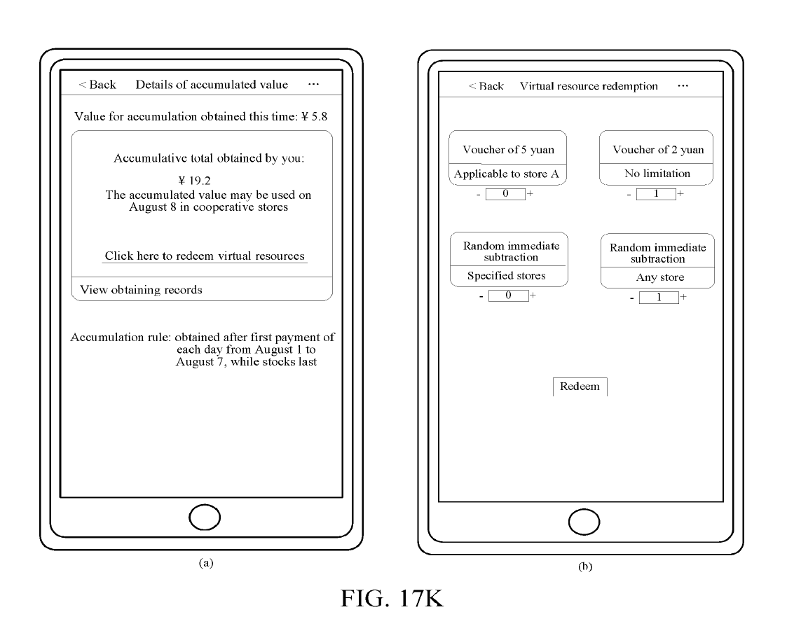

Certainly, in the process of obtaining a credit score, payment data or shopping data of a user may be obtained based on daily consumption behaviors of the user, and is used to encourage subsequent transactions of the user. Referring to the following service processing flow, FIG. 17A is a flowchart of a service processing method according to an embodiment of this application. Interaction bodies are a first user terminal and a server. Referring to FIG. 17A, the method includes the following steps:

1701: A first user terminal sends a value transfer request to a server, the value transfer request being used to instruct a first user to transfer a first value to a second user.

The value transfer request may include a user identifier of the first user, a user identifier of the second user, and the first value.

For example, the process of sending, by the first user terminal, the value transfer request to the server may be that: a first payment interface for payment to the second user may be displayed on the first user terminal, the first user may input the to-be-transferred first value on the first payment interface, and click a payment option of the payment interface to trigger the first user terminal to send the value transfer request to the server.

Certainly, to transfer a value between the first user and the second user, a second user terminal may alternatively send a corresponding value transfer request to the server. For example, the process of sending, by the second user terminal, the value transfer request to the server may be that: the first user triggers a second payment interface for payment to the second user on the first user terminal, where the second payment interface includes user information of the first user, and the form of the user information may be a two-dimensional code, a bar code, or the like, and after obtaining the user information of the first user by using a specified device, the second user terminal sends the value transfer request of the to-be-transferred value to the server. The specified device has a function of scanning a two-dimensional code or a bar code.

1702: If determining that current time reaches preset time after receiving the value transfer request, the server obtains an accumulated value of the first user.

A specified activity time period is used to indicate activity time of a specified activity. The specified activity time period may last from 0:00 of a first specified date to 24:00 of a second specified date, such as from 0:00 of August 1 to 24:00 of August 8. The specified activity time period may be preset by the server according to actual requirements. This embodiment of this application makes no limitation to start time, end time, and an activity duration of the specified activity time period. The preset time is a period of time at the end of the specified activity time period. For example, if the specified activity time period is from 0:00 of August 1 to 24:00 of August 8, the preset time may be from 0:00 of August 8 to 24:00 of August 8, or the like. The preset time may also be preset by the server according to actual requirements, and is not limited in this embodiment of this application. The current time is time when the value transfer request is received.

Note that to encourage the first user (that is, a buyer user) to perform consumption for a plurality of times in the specified activity time period, in the specified activity time period, the server in this embodiment of this application may issue a plurality of values for accumulation to the first user according to a plurality of value transfer activities of the first user. The accumulated value may be used in the preset time, to deduct fees needing to be paid to the second user (a seller user). The preset time is a time period when the first user uses the accumulated value. A time period before the preset time in the specified activity time period is a time period when the first user performs value accumulation.

Further, when the plurality of values for accumulation are issued, the specific values may further be determined according to a credibility reference value of the first user. A larger credibility reference value indicates larger issued values. In this way, consumption behaviors of marquee buyers are rewarded.

In step 1702, a use condition of the accumulated value is that the current time reaches the preset time. In this case, the server may obtain the accumulated value of the first user, to facilitate subsequent use of the accumulated value.

In this embodiment of this application, a limit condition of using the accumulation value may further be added based on that the current time reaches the preset time.

In an implementation, to encourage the buyer user to perform consumption at different seller users, the number of times of accumulated value based value transfer of the second user in the specified activity time period may be limited. Specifically, when determining that the current time reaches the preset time, the server determines whether the number of times of accumulated value based value transfer of the second user in the specified activity time period is greater than a preset number of times of transfer of the second user. If not, the step of obtaining the accumulated value of the first user is performed. If yes, a value transfer operation corresponding to the value transfer request is performed.

The accumulated value based value transfer may include at least one of value transfer using the accumulated value and value transfer for value accumulation. Preset numbers of times of transfer of different second users may be the same or may be different. The preset number of times of transfer of the second user may be determined according to a credit level of the second user. For example, a higher credit level of the second user indicates a larger corresponding preset number of times of transfer.

The credit level of the second user is used to represent a credibility of the second user. In this embodiment of this application, the credit level of the second user may be determined according to online behavior data of the second user, according to offline associated behavior data of the second user, according to the online behavior data and the offline associated behavior data of the second user, or according to other data of the second user. This is not limited in this embodiment of this application. The online behavior data of the second user may include at least one of buyer evaluation behavior data, after sales service data, and complaint data. The offline associated behavior data may include at least one of physical store transaction data and online to offline (O2O) life service data. Certainly, the online behavior data and the offline associated behavior data may separately include or be other data. This is not limited in this embodiment of this application.

To encourage the buyer user to perform consumption at a specified seller user, a limit condition that the second user is included in a specified user list may further be added based on the use condition of the accumulated value. The specified list is used to store a plurality of second users that can use the accumulated value. The plurality of second users may be seller users participating in the specified activity. Specifically, after determining that the second user is included in the specified user list, the server performs the step of obtaining an accumulated value of the first user.

Before using the accumulated value, the first user needs to perform value accumulation. The following describes the process of the value accumulation. Referring to FIG. 17B, after step 1701, this embodiment of this application may further include the following step 0a to step 0c:

Step 0a: After receiving the value transfer request, if current time is in a specified activity time period and does not reach preset time, the server issues a second value to the first user after performing a value transfer operation corresponding to the value transfer request.

If the server is provided with the specified activity time period and the preset time, after receiving the value transfer request, the server determines whether the current time is in the specified activity time period, if yes, determines whether the current time reaches the preset time, and if the current time does not reach the preset time, performs the process of value accumulation.

Performing, by the server, a value transfer operation corresponding to the value transfer request is transferring, by the server, the first value from the first user to the second user. Issuing, by the server, a second value to the first user is storing, by the server, the second value in a manner of correspondence to the first user, such as storing the second value in a manner of correspondence to the user identifier of the first user.

The second value is a value for accumulation. The second value may be a value stored in a specified account stored in the server. The specified account may be regarded as a bonus pool provided by the server for a plurality of first users. Values stored in the specified account are used for issuing to at least one first user according to a value accumulation condition.

The value accumulation condition may be one of the following several conditions:

Condition 1: the current time when value transfer is performed is the specified activity time period, and does not reach the preset time.

Condition 2: the current time is in any sub time period of the specified activity time period, and does not reach the preset time, and the value transfer request is a first value transfer request of the first user in the current sub time period.

The specified activity time period may include a plurality of sub time periods. For example, when the specified activity time period includes Friday to Sunday, each day may be used as a sub time period of the specified activity time period, or several hours of each day are divided as a sub time period of the specified activity time period. This is not limited in this embodiment of this application.

Condition 3: the current time is in any sub time period of the specified activity time period, and does not reach the preset time, and the value transfer request is a first value transfer request, for performing value transfer to the second user, of the first user in the current sub time period.

To encourage the buyer user to perform consumption at different sellers, the condition 3 defines the value transfer request as the first value transfer request for performing value transfer to the second user based on the condition 2.

Condition 4: the second user is included in the specified user list, and the specified user list is used to store a plurality of second users that can use the accumulated value.

Note that in step 0a, the value accumulation condition is the condition 1. Because values stored in the specified account are limited, to ensure that all of the plurality of first users that participate in the specified activity can obtain an accumulated value, in an implementation, a limit value of the second value obtained by each first user may be limited. For example, the second value issued to the first user each time cannot exceed a first preset threshold. In another implementation, the second value may be issued to the first user when the first value transferred by the first user exceeds a second preset threshold. The first preset threshold and the second preset threshold may both be preset or modified by the server. This is not limited in this embodiment of this application.

In another embodiment, the condition 2 to the condition 4 may alternatively be used as the value accumulation condition. The condition 2 to the condition 4 may be separately used as the value accumulation condition, or may be used as the value accumulation condition after being combined. For example, the condition 4 may be separately combined with the condition 2 and the condition 3 as the value accumulation condition. Certainly, the condition 4 may alternatively be combined with the condition 1 as the value accumulation condition. This is not limited in this embodiment of this application. When the value accumulation condition is the condition 2, the server may determine whether the value transfer request is the first value transfer request of the first user in the current sub time period when determining that the current time is in any sub time period of the specified activity time period, and does not reach the preset time, and if yes, perform the step of issuing a second value to the first user after performing the value transfer operation corresponding to the value transfer request. When the value accumulation condition is the condition 3, the server may determine whether the value transfer request is the first value transfer request, for performing value transfer to the second user, of the first user in the current sub time period when determining that the current time is in any sub time period of the specified activity time period, and does not reach the preset time, and if yes, perform the step of issuing a second value to the first user after performing the value transfer operation corresponding to the value transfer request.

In this embodiment of this application, the manner of issuing, by the server, a second value to the first user may be one of the following three manners:

The three manners may be applicable to any one of the foregoing value accumulation conditions and a combination thereof.

First manner: the server randomly generates and issues the second value that can be used in the preset time.

In this manner, the server may randomly generate a first resource package based on the specified account according to a target limit value and the accumulated value of the first user. The first resource package is used to provide the second value that can be used in the preset time. The server may store the second value in a manner of correspondence to the first user.

The target limit value is a maximum value that the first user can accumulate in the specified activity time period. That is, the value accumulated by the first user in the specified activity time period cannot exceed the target limit value. The accumulated value of the first user is a value accumulated by the first user before the value transfer of this time.

The server may determine a maximum value that can be issued to the first user this time according to the target limit value and the accumulated value of the first user. Subsequently, the server randomly obtains, from the specified account, a second value less than the maximum value that can be issued this time, and generates the first resource package according to the second value. The first resource package may have a first package identifier, which is used to indicate that the second value in the first resource package is used for use in the preset time.

Second manner: the server obtains a second value that can be used in the preset time from a plurality of allocated values, and issues the second value to the first user.

In this manner, the server obtains a second resource package from a plurality of resource packages of the specified account according to the target limit value and the accumulated value of the first user. The second resource package is used to provide the second value that can be used in the preset time. The server may store the second value in a manner of correspondence to the first user.

The meaning of the target limit value is the same as that of the target limit value of the first manner. Details are not described herein again. Different from the first manner, in this manner, values in the specific account may be pre-allocated to a plurality of resource packages. Different resource packages may contain different values. Specifically, the server may preset several values and the number of resource packages corresponding to each value, and allocate the values in the specified account to the plurality of resource packages according to the several preset values and the number of resource packages corresponding to each value. For example, the several values preset by the server include 0.5 yuan, 0.88 yuan, 1.2 yuan, and 8 yuan, and the numbers of corresponding resource packages are respectively 100, 80, 50, and 5. Then the server may divide the values in the specified account into 100 resource packages of 0.5 yuan, 80 resource packages of 0.88 yuan, 50 resource packages of 1.2 yuan, and 5 resource packages of 8 yuan.

The server may determine a maximum value that can be issued to the first user this time according to the target limit value and the accumulated value of the first user. Subsequently, the server obtains, from the specified account, a second resource package including a value less than the maximum value that can be issued this time. The second resource package may have a second package identifier, which is used to indicate that the second value in the second resource package is used for use in the preset time.

Note that the second package identifier may be the same as or different from the first package identifier in the first manner. This is not limited in this embodiment of this application.

Third manner: the server randomly generates and issues the second value that can be used at any time.

In this manner, to arouse the consumption interest of the first user, the server may further issue the second value that can be used at any time to the first user. The second value is added to an account of the first user by the server, so that the first user can use the second value at any time by using the account of the first user.

Specifically, the server may randomly generate a third resource package. The third resource package may have a third package identifier, which is used to indicate that a value in the third resource package may be used at any time. The server may preset a rule for issuing the third resource package. For example, the rule may be issuing a third resource package after a preset number of values for accumulation are issued each time, or the rule may be including a second value first issued in any sub time period of the specified activity time period into the third resource package.

Step 0b: The server sends a value accumulation message to a first user terminal, the value accumulation message including the second value and an accumulated value of the first user.

To better display the result of value issuance to enable the first user to learn the situation of value accumulation in real time, the server may carry the second value issued this time and the accumulated value of the first user after the second value is issued into the value accumulation message for transmission to the first user terminal.

Step 0c: After receiving the value accumulation message of the server, the first user terminal displays the second value and the accumulated value of the first user.

The first user terminal displays the second value and the accumulated value of the first user according to the received value accumulation message. For example, the first user terminal may display the value accumulation message in a specified interface. The value accumulation message may be displayed according to a preset template. For example, the second value for accumulation this time may be displayed in a highlighted manner in the specified interface, such as being displayed by using a big font, or being displayed in the center of the specified interface for display. The accumulated value of the first user may be displayed below the second value by using a relatively small font. In addition, to enable the first user to better learn the activity rule of the specified activity, the value accumulation message may further include related information of the specified activity, such as information like the accumulation manner and use time of the accumulated value. As shown in FIG. 17C, FIG. 17C is a display schematic diagram of a value accumulation message. As shown in FIG. 17C, the specified interface may be a message notification interface. FIG. 17C further includes a detail viewing option, which is used to display a first detail interface of the accumulated value of the first user. For example, when detecting a trigger operation on the detail viewing option of the accumulated value, the first user terminal may display the first detail interface of the accumulated value of the first user. As shown in FIG. 17D, in the first detail interface, the value for accumulation this time is displayed, the current accumulated value is displayed in a highlighted manner, and related information of the specified activity such as the accumulation manner of the accumulated value is displayed.

The accumulated value of the first user is obtained by means of value transfer for at least once by the first user. Therefore, to display the accumulated value of the first user in a more detailed manner, the first user terminal may further display details of the accumulated value. The process may include: when detecting a record obtaining and viewing operation on the accumulated value of the first user, obtaining, from the server, at least one value obtained by the first user in the specified activity time period; and displaying the at least one value in a time sequence. Specifically, the first user terminal may display the at least one value in a time sequence in a second detail interface of the accumulated value. For example, each value and a corresponding obtaining data are correspondingly displayed in the second detail interface. Referring to FIG. 17E, FIG. 17E is a display schematic diagram of details of an accumulated value.

As can be learned from the value accumulation process described above, the accumulated value of the first user may be obtained by the first user in the specified activity time period by means of value transfer for at least once. After performing the value transfer, the first user may deduct, by using the accumulated value, a value transferred to the second user in the preset time. The process of using the accumulated value is described below.

1703: The server determines a deduction value, and determines a difference between the first value and the deduction value as an actual transfer value.

After obtaining the accumulated value of the first user, in the process of the value transfer from the first user to the second user, the server may deduct, by using the accumulated value, the first value needing to be transferred by the first user to the second user. The manner of determining the deduction value by the server may be one of the following several manners:

First manner: if the first value is greater than the accumulated value of the first user, the accumulated value of the first user is determined as the deduction value.

In this manner, the accumulated value of the first user may be used as the deduction value at a time. For example, assuming that the accumulated value of the first user is 5 yuan, if the first value is 10 yuan, that is, the first value is greater than the accumulated value of the first user, it may be determined that the deduction value is 5 yuan.

Second manner: if the first value is less than the accumulated value of the first user, the first value is determined as the deduction value.

In this manner, the accumulated value of the first user may be used for a plurality of times. For example, assuming that the accumulated value of the first user is still 5 yuan, if the first value is 2.4 yuan, that is, the first value is less than the accumulated value of the first user, it may be determined that the deduction value is 2.4 yuan. In this way, the actual transfer value that the first user actually needs to pay is 0, and payment this time may be completed by subsequently deducting 2.4 yuan from the accumulated value of the first user. After 2.4 yuan is deducted from the accumulated value of the first user, the remaining accumulated value is 2.6 yuan. The remaining accumulated value may further be used during subsequent value transfer of the first user.

Third manner: if the first value is less than the accumulated value of the first user, a preset percentage of the first value is determined as the deduction value.

In this manner, the accumulated value of the first user may be used for a plurality of times. For example, assuming that the accumulated value of the first user is still 5 yuan, if the first value is 3 yuan, and the preset percentage is 20%, it may be determined that the deduction value is 20% of 3 yuan, that is, 0.6 yuan. In this way, the actual transfer value that the first user actually needs to pay is 2.4 yuan, and the 0.6 yuan needs to be subsequently deducted from the accumulated value of the first user. After 0.6 yuan is deducted from the accumulated value of the first user, the remaining accumulated value is 4.4 yuan. The remaining accumulated value may further be used during subsequent value transfer of the first user.

Fourth manner: the deduction value is determined according to a credit level of the second user and the accumulated value of the first user, where the deduction value is not greater than the accumulated value of the first user, and the credit level of the second user is in a positive correlation with the deduction value.

A higher credit level of the second user indicates a larger corresponding deduction value. Specifically, the server may preset a list of correspondence between credit levels and deduction values. For example, the server may correspondingly set maximum deduction values for different credit levels (such as a credit level 1 or a credit level 10). A higher credit level indicates a larger corresponding maximum deduction value; or the server may divide the credit levels into different ranges, and set one maximum deduction value corresponding to one credit level range, and the like. If the accumulated value of the first user is greater than a maximum deduction value of the second user, the maximum deduction value is determined as the deduction value. If the accumulated value of the first user is not less than the maximum deduction value of the second user, the accumulated value of the first user is determined as the deduction value.

For example, assuming that the accumulated value of the first user is still 5 yuan, if the first value is 10 yuan, the credit level of the second user is a level 8, and the corresponding maximum deduction value is 4 yuan, as can be learned from that the maximum deduction value 4 yuan is less than the accumulated value 5 yuan, the deduction value is 4 yuan; if the corresponding maximum deduction value of the second user is 6 yuan, as can be learned from that the maximum deduction value 6 yuan is greater than the accumulated value 5 yuan, the deduction value is 5 yuan.

1704: The server deducts the deduction value from the accumulated value of the first user, transfers the deduction value from a specified account to the second user, and transfers the actual transfer value from an account of the first user to the second user.

The accumulated value is used in the value transfer process, so that a value transferred from the first user to the second user is less than the first value actually needing to be paid, thereby improving the consumption enthusiasm of the first user.

Step 1702 to step 1704 are the process of performing value transfer between the first user and the second user by the server according to the first value and the accumulated value of the first user, and then the server may further notify the first user of the result of the value transfer. The specific process includes the following step 1705 and step 1706.

1705: The server generates a payment success message, the payment success message including the actual transfer value and the deduction value, and sends the payment success message to the first user terminal.

After completing the value transfer between the first user and the second user by using the accumulated value, the server generates the payment success message. The payment success message is used to display detailed information of payment of this time of the first user on the first user terminal. In addition, if in this case, the accumulated value of the first user is not zero, the server may further carry the accumulated value of the first user into the payment success message for transmission to the first user terminal.

1706: After receiving the payment success message, the first user terminal displays the actual transfer value and the deduction value in a process of the value transfer of this time.

The first user terminal may display the payment success message in a transaction detail interface, that is, display the actual transfer value and the deduction value in a process of the value transfer of this time. In addition, when the payment success message carries the accumulated value of the first user, the first user terminal may further display the accumulated value of the first user. Referring to FIG. 17F, FIG. 17F is a display schematic diagram of a payment success message according to an embodiment of this application. Certainly, to appreciate the first user for participating in the specified activity, the first user terminal may further display a thankyou interface of activity participation, as shown in FIG. 17G.

An embodiment of this application further provides a function of recommending a specified activity, a function of transferring an accumulated value, and a virtual resource redemption function of an accumulated value. The three functions are respectively introduced below:

I. Function of Recommending a Specified Activity

In this embodiment of this application, to improve user engagement of a specified activity, a function of recommending a specified activity may further be provided. The recommendation process may include the following step 1a to step 1d.

Step 1a: After issuing a second value to a first user, a server obtains at least one third user from a user relationship chain of the first user, where the at least one third user is a user that does not participate in a specified activity.

When obtaining the at least one third user, the server may determine, according to a credibility reference value of each third user, whether to select the third user. If the credibility reference value of the third user is greater than or equal to the preset threshold, the third user is selected, and if the credibility reference value of the third user is less than the preset threshold, the third user is ignored.

Step 1b: The server sends an activity recommendation prompt message including at least one third user to a first user terminal.

Step 1c: When receiving the activity recommendation prompt message of the server, the first user terminal displays the at least one third user.

The manner of displaying the at least one third user may be one of the following several manners:

First display manner: the activity recommendation prompt message may be a push message, and when detecting a trigger operation on the activity recommendation prompt message, the first user terminal displays the at least one third user.

Second display manner: the activity recommendation prompt message is displayed in an interface alone, and the at least one third user is displayed in the interface.

When third users are displayed, the third users may further be displayed in a manner of sorting according to credibility reference values of the third users. A larger credibility reference value indicates a higher sort position where the third user is displayed.

Third display manner: the activity recommendation prompt message and the value accumulation message are displayed in a specified interface. For example, a slidable list may be displayed below the value accumulation message. The at least one third user may be displayed in the slidable list. Alternatively, given that the display area of the specified interface is limited, a recommendation link corresponding to the activity recommendation prompt message may further be first displayed in the specified interface. When a trigger operation on the recommendation link is detected, the at least one third user is displayed in another interface.

Note that corresponding to the third display manner, the server may send the value accumulation message and the activity recommendation prompt message together to the first user terminal. As shown in FIG. 17H, FIG. 17H is a schematic diagram of displaying an activity recommendation message in the third display manner.

Step 1d: The first user terminal recommends the specified activity to the at least one third user according to a recommendation confirmation operation on the at least one third user.

The first user may select one or more third users in the at least one third user displayed by the first user terminal. The first user may trigger the recommendation confirmation operation by clicking a recommendation confirmation button. The first user terminal sends recommendation confirmation messages of the selected one or more third users to the server. The server sends a recommendation message of the specified activity to terminals where the one or more third users are located.

II. Function of Transferring an Accumulated Value

In this embodiment of this application, to improve the frequency of interaction between different users, the function of transferring an accumulated value may further be provided, including the following two cases:

First case: all accumulated values are transferred, and the process may include the following step 2a to step 2c:

Step 2a: In a specified activity time period, when detecting a transfer operation on an accumulated value, a first user terminal displays a user relationship chain of a first user.

The first user terminal may display a first transfer option for the accumulated value. The first transfer operation may be displayed in a detail interface of the accumulated value. When detecting a trigger operation on the first transfer option, the first user terminal may display the user relationship chain of the first user. As shown in FIG. 17I, FIG. 17I is a display schematic diagram of a transfer option of an accumulated value. After the transfer option is triggered in FIG. 17I, the first user terminal may display the user relationship chain of the first user.

Step 2b: The first user terminal sends a first transfer request to a server according to a first target user determined in the user relationship chain, where the first transfer request is used to instruct to transfer the accumulated value of the first user.

The first user may select a friend user in the user relationship chain as the first target user for accumulated value transfer. The first transfer request may carry a user identifier of the first target user and a first transfer identifier. The first transfer identifier is used to indicate that the transfer request is used to transfer the accumulated value of the first user.

Step 2c: After receiving the first transfer request, the server determines the first target user indicated by the first transfer request; and when determining that the first target user does not receive accumulated value transfer in the specified activity time period, the server transfers the accumulated value of the first user as an accumulated value of the first target user.

The accumulated value of the first user is less than a first transfer threshold. The first transfer threshold may be preset or modified by the server. This is not limited in this embodiment of this application.

Note that to avoid security risks brought by a plurality of times of transfer between users, it may be defined that each user can receive accumulated value transfer for one time. Specifically, the server may record the number of times of accumulated value transfer received by each user, and a transfer value of the accumulated value. The number of times of the accumulated value transfer may be 0 or 1. When the number of times of the accumulated value transfer of the first target user is 0, the server determines that the first target user does not receive accumulated value transfer in the specified activity time period.

To further improve the security of the accumulated value transfer, the number of times of accumulated value transfer by the first user to other users may further be limited. For example, it is defined that the first user can perform the accumulated value transfer to other users for one time. For example, the server may record the number of times of accumulated value transfer by each user to other users, and when the first user does not transfer the accumulated value to other users, the server processes the first transfer request of the first user.

Second case: any value that forms the accumulated value is transferred, and the process may include the following step 3a to step 3c:

Step 3a: In a specified activity time period, when detecting a transfer operation on any value for accumulation, a first user terminal displays a user relationship chain of a first user.

In a detail interface of the accumulated value, the first user terminal may display a transfer option corresponding to an entry where each value is located. When detecting a trigger operation on a transfer option of any value, the first user terminal displays the user relationship chain of the first user. As shown in FIG. 17J, FIG. 17J is a display schematic diagram of a transfer option of an accumulated value.

Step 3b: The first user terminal sends a second transfer request to a server according to a second target user determined in the user relationship chain, where the second transfer request is used to instruct transfer of a value obtained by the first user in any sub time period.

The first user may select a friend user in the user relationship chain as the second target user for accumulated value transfer. The second transfer request may carry a user identifier of the second target user and a second transfer identifier. The second transfer identifier is used to indicate that the transfer request is used to transfer a value obtained by the first user in any sub time period.

Step 3c: When receiving the second transfer request, the server determines the second target user indicated by the second transfer request, and when determining that the second target user does not perform value accumulation in the corresponding time period, the server transfers a second value obtained by the first user in the sub time period as an accumulated value of the second target user.

The value transferred by the first user is less than a second transfer threshold. The second transfer threshold may be preset or modified by the server. This is not limited in this embodiment of this application. The second transfer threshold may be less than the first transfer threshold in step 2b.

Note that to avoid security risks brought by a plurality of times of transfer between users, the second transfer request may further include time when a to-be-transferred value is obtained. When determining that the second target user does not perform value accumulation in a sub time period of the time when the to-be-transferred value is obtained, the server processes the second transfer request, and otherwise, ignores the second transfer request.

To further improve the security of the accumulated value transfer, the number of times of transfer of a value obtained by a user in a sub time period may further be limited, or the number of times of accumulated value transfer received by the user may be limited. The two limiting manners are the same as the description in step 2c, and details are not described herein again.

III. Virtual Resource Redemption Function of an Accumulated Value

In this embodiment of this application, to improve the diversity of use paths of an accumulated value, the virtual resource redemption function of the accumulated value may further be provided, and the function may specifically include the following step 4a to step 4d:

Step 4a: If detecting a virtual resource redemption operation on an accumulated value in preset time, a first user terminal displays a plurality of virtual resources.

The first user terminal may display a virtual resource redemption option in a related interface of the accumulated value (such as a detail interface of the accumulated value). When detecting a trigger operation on the redemption option, the first user terminal displays the plurality of virtual resources. The first user terminal may display the plurality of virtual resources in a virtual resource redemption page. As shown in FIG. 17K, FIG. 17K is a schematic diagram of an interface for virtual resource redemption, and FIG. (a) in FIG. 17K is a display schematic diagram for displaying the redemption option in the detail interface of the an accumulated value. The redemption option shown in FIG. (a) in FIG. 17K is a link containing text “click here to redeem virtual resources”. FIG. (b) in FIG. 17K is a virtual resource redemption page. The type of virtual resources needing to be redeemed and the corresponding number may be selected in the virtual resource redemption page.

The virtual resources may be vouchers of different values and one or more opportunities of random immediate subtraction of a specified second user. The virtual resource may have a use period. For example, the use period may be 30 days after the virtual resource is redeemed, or may be a period having specified dates, such as September 1 to September 30. This is not limited in this embodiment of this application.

Step 4b: The first user terminal obtains at least one target virtual resource from the plurality of virtual resources, and sends a virtual resource redemption request to a server according to a resource type of the at least one target virtual resource and the number of to-be-redeemed target virtual resources.

Resource types of virtual resources may include vouchers, opportunities of random immediate subtraction, and the like. For a same virtual resource, the first user may select the number for redemption, that is, the number of to-be-redeemed virtual resources.

Step 4c: After receiving the virtual resource redemption request of a first user, the server obtains a redemption value of the at least one target virtual resource according to the resource type of the at least one target virtual resource and the number of to-be-redeemed target virtual resources.

The server may calculate, according to resource types of different target virtual resources and the number of to-be-redeemed target virtual resources, the redemption value for redeeming the at least one target virtual resource. For example, the at least one target virtual resource includes a voucher of 5 yuan and an opportunity of random immediate subtraction. Assuming that an opportunity of random immediate subtraction needs to be redeemed by using a value of 2 yuan, the redemption value of the at least one target virtual resource is 7 yuan.

Step 4d: If determining that an accumulated value of the first user is not less than the redemption value, the server deducts the redemption value from the accumulated value of the first user, and issues the at least one target virtual resource to the first user.

The server may obtain the accumulated value of the first user, and determine whether the accumulated value is less than the redemption value. If not, the server deducts the redemption value from the accumulated value of the first user, and stores the at least one target virtual resource in a manner of correspondence to the first user. When subsequently performing value transfer, the first user may select the obtained virtual resources. If the accumulated value of the first user is less than the redemption value, the virtual resource redemption request of this time is rejected, and a reason for rejection is fed back to the first user terminal. For example, the reason for rejection may be that the accumulated value is insufficient. For example, if the redemption value of the at least one target virtual resource is 7 yuan, when the accumulated value of the first user is greater than or equal to 7 yuan, the step of deducting the redemption value from the accumulated value of the first user, and issuing the at least one target virtual resource to the first user is performed.

According to the method provided in this embodiment of this application, a buyer user performs a plurality of times of value transfer in a particular time period, at least one value for accumulation may be issued to the buyer user, an accumulated value of the buyer user is obtained, and the accumulated value may be completely used to deduct a value needing to be transferred to a seller user, so that the buyer user can be encouraged to perform consumption for a plurality of times in the particular time period, to increase the number of times of service processing, thereby improving the efficiency of the service processing.

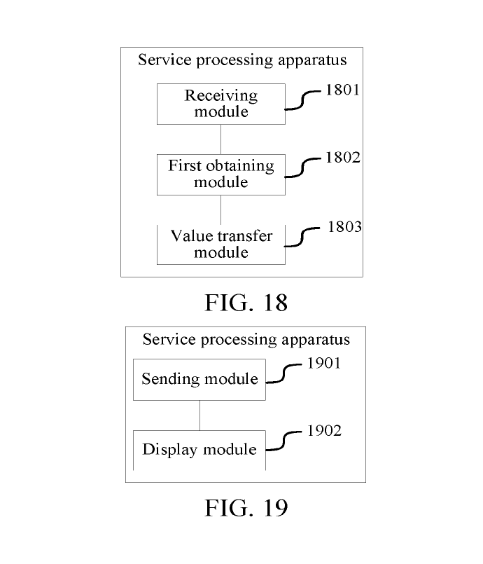

FIG. 18 is a block diagram of a service processing apparatus according to an embodiment of this application. Referring to FIG. 18, the apparatus includes a receiving module 1801, a first obtaining module 1802, and a value transfer module 1803.

The receiving module 1801 is connected to the first obtaining module 1802, and is configured to receive a value transfer request, the value transfer request being used to instruct a first user to transfer a first value to a second user, and the second user being used to provide a service for the first user. The first obtaining module 1802 is connected to the value transfer module 1803, and is configured to obtain an accumulated value of the first user if current time reaches preset time, the accumulated value being obtained by the first user in a specified activity time period by means of value transfer for at least once. The value transfer module 1803 is configured to perform value transfer between the first user and the second user according to the first value and the accumulated value of the first user.

In a possible implementation, the apparatus further includes: a value issuing module, configured to: if the current time is in the specified activity time period and does not reach the preset time, issue a second value to the first user after a value transfer operation corresponding to the value transfer request is performed.

In a possible implementation, the apparatus further includes:

a first judgment module, configured to: determine whether the number of times of accumulated value based value transfer of the second user in the specified activity time period is greater than a preset number of times of transfer of the second user; if not, perform the step of obtaining an accumulated value of the first user; and if yes, perform the value transfer operation corresponding to the value transfer request.

In a possible implementation, the preset number of times of transfer of the second user is determined according to a credit level of the second user.

In a possible implementation, the value transfer module is configured to determine a deduction value; determine a difference between the first value and the deduction value as an actual transfer value; deduct the deduction value from the accumulated value of the first user, and transfer the deduction value from a specified account to the second user; and transfer the actual transfer value from an account of the first user to the second user.

In a possible implementation, the value transfer module is configured to: if the first value is greater than the accumulated value of the first user, determine the accumulated value of the first user as the deduction value; or, if the first value is less than the accumulated value of the first user, determine the first value as the deduction value; or, if the first value is less than the accumulated value of the first user, determine a preset percentage of the first value as the deduction value; or, determine the deduction value according to a credit level of the second user and the accumulated value of the first user, where the deduction value is not greater than the accumulated value of the first user, and the credit level of the second user is in a positive correlation with the deduction value.

In a possible implementation, the apparatus further includes:

a generation module, configured to generate a payment success message, where the payment success message includes an actual transfer value and a deduction value; and a first sending module, configured to send the payment success message to a first user terminal, where the first user terminal displays the actual transfer value and the deduction value.

In a possible implementation, the apparatus further includes:

a second obtaining module, configured to: if a virtual resource redemption request of the first user is received in the preset time, obtain a redemption value of at least one target virtual resource according to a resource type of the at least one target virtual resource and the number of to-be-redeemed target virtual resources, where the virtual resource redemption request is used to redeem the at least one target virtual resource; and a virtual resource issuing module, configured to: if the accumulated value of the first user is not less than the redemption value, deduct the redemption value from the accumulated value of the first user, and issue the at least one target virtual resource to the first user.

In a possible implementation, the apparatus further includes:

a second judgment module, configured to: if the current time is in any sub time period of the specified activity time period, and does not reach the preset time, determine whether the value transfer request is a first value transfer request of the first user in the current sub time period; and if yes, perform the step of issuing a second value to the first user after the value transfer operation corresponding to the value transfer request is performed; or, if the current time is in any sub time period of the specified activity time period, and does not reach the preset time, determine whether the value transfer request is a first value transfer request, for performing value transfer to the second user, of the first user in the current sub time period; and if yes, perform the step of issuing a second value to the first user after the value transfer operation corresponding to the value transfer request is performed.

In a possible implementation, the value issuing module is configured to randomly generate a first resource package based on a specified account according to a target limit value and the accumulated value of the first user, where the first resource package is used to provide the second value that can be used in the preset time, and store the second value in a manner of correspondence to the first user; or, obtain a second resource package from a plurality of resource packages of the specified account according to the target limit value and the accumulated value of the first user, where the second resource package is used to provide the second value that can be used in the preset time, and store the second value in a manner of correspondence to the first user; or, randomly generate a third resource package, where the third resource package is used to provide the second value that can be used at any time, and add the second value to an account of the first user.

In a possible implementation, the apparatus further includes:

a second sending module, configured to send a value accumulation message to the first user, where the value accumulation message includes a second value and an accumulated value of the first user, and the first user terminal displays the second value and the accumulated value of the first user.

In a possible implementation, the apparatus further includes:

a third obtaining module, configured to obtain at least one third user from a user relationship chain of the first user, where the at least one third user is a user that does not participate in a specified activity; and a third sending module, configured to send an activity recommendation prompt message including the at least one third user to a first user terminal, where the first user recommends the specified activity to the at least one third user according to the activity recommendation prompt message.

In a possible implementation, the apparatus further includes:

a value transfer module, configured to: when a first transfer request of the first user for the accumulated value of the first user is received, determine a first target user indicated by the first transfer request; and if the first target user does not receive accumulated value transfer in the specified activity time period, transfer the accumulated value of the first user as an accumulated value of the first target user; or when a second transfer request of the first user for the second value obtained in any sub time period is received, determine a second target user indicated by the second transfer request; and if the second target user does not perform value accumulation in the corresponding time period, transfer the second value obtained by the first user in the sub time period as an accumulated value of the second target user, where the accumulated value of the first user is greater than a first transfer threshold, and the second value transferred by the first user is less than a second transfer threshold.

In a possible implementation, the second user is included in the specified user list, and the specified user list is used to store a plurality of second users that can use the accumulated value.

The apparatus provided in this embodiment of the present disclosure may issue at least one value for accumulation to a first user based on a plurality of times of value transfer of the first user in a particular time period, and obtain an accumulated value of the first user, and the accumulated value may be completely used to deduct a value needing to be transferred to a second user, so that a buyer user can be encouraged to perform consumption for a plurality of times in the particular time period, to increase the number of times of service processing, thereby improving the efficiency of the service processing.

FIG. 19 is a block diagram of a service processing apparatus according to an embodiment of this application. Referring to FIG. 19, the apparatus includes a sending module 1901 and a display module 1902.

The sending module 1901 is connected to the display module 1902, and is configured to send a value transfer request to a server. The value transfer request is used to instruct a first user to transfer a first value to a second user. The server performs value transfer according to an accumulated value of the first user when determining that current time reaches preset time. The accumulated value of the first user is obtained by the first user in a specified activity time period by means of value transfer for at least once. The display module 1902 is configured to display an actual transfer value and a deduction value of the first user in a process of the value transfer of this time after a payment success message is received.

In a possible implementation, the apparatus further includes:

a receiving module, configured to receive a value accumulation message of the server, where the value accumulation message includes a second value and the accumulated value of the first user, and the value accumulation message is returned by the server after the server issues the second value to the first user when determining that the current time is in a specified activity time period, and does not reach the preset time; and the display module, configured to display the second value and the accumulated value of the first user.

In a possible implementation, the apparatus further includes:

a first obtaining module, configured to: when a record obtaining and viewing operation on the accumulated value of the first user is detected, obtain, from the server, at least one value obtained by the first user in the specified activity time period, and the display module, further configured to display at least one value in a time sequence.

In a possible implementation, the apparatus further includes:

the display module, further configured to: when an activity recommendation prompt message of the server is received, display at least one third user, where the activity recommendation prompt message includes the at least one third user, and the at least one third user is a user, that does not participate in a specified activity, in a user relationship chain of the first user; and a recommendation module, configured to recommend the specified activity to the at least one third user according to a recommendation confirmation operation on the at least one third user.

In a possible implementation, the apparatus further includes:

the display module, further configured to: when a transfer operation on the accumulated value is detected in the specified activity time period, display the user relationship chain of the first user; and the sending module, further configured to send a first transfer request to the server according to a first target user determined in the user relationship chain; or, the display module, further configured to: when a transfer operation on any value for accumulation is detected in the specified activity time period, display the user relationship chain of the first user; and the sending module, further configured to send a second transfer request to the server according to a second target user determined in the user relationship chain.

In a possible implementation, the apparatus further includes:

the display module, further configured to: if a virtual resource redemption operation on the accumulated value is detected in the preset time, display a plurality of virtual resources;

a second obtaining module, configured to obtain at least one target virtual resource from the plurality of virtual resources; and

the sending module, further configured to send a virtual resource redemption request to the server.

The apparatus provided in this embodiment of the present disclosure may issue at least one value for accumulation to a first user based on a plurality of times of value transfer of the first user in a particular time period, and obtain an accumulated value of the first user, and the accumulated value may be completely used to deduct a value needing to be transferred to a second user, so that a buyer user can be encouraged to perform consumption for a plurality of times in the particular time period, to increase the number of times of service processing, thereby improving the efficiency of the service processing.

Note that when the service processing apparatus provided in the foregoing embodiment processes services, the foregoing functional modules are described for exemplary purposes. In actual applications, the functions may be allocated to different functional modules according to requirements. That is, the internal structure of the device is divided into different functional modules to complete all or some of the functions described above. In addition, the embodiment of the service processing apparatus provided in the foregoing embodiment is based on the same idea as the embodiment of the service processing method. For the specific implementation process, refer to the method embodiment, and the details are not described herein again.

Note that “a plurality of” mentioned in this text is two or more. “And/or” describes an association between associated objects, and indicates that three relationships may exist. For example, A and/or B may indicate three cases: A exists alone, A and B both exist, and B exists alone. The character “I” usually indicates that the associated objects before and behind the character is in an “or” relationship.

A person of ordinary skill in the art may understand that all or some of the steps of the foregoing embodiments may be implemented by using hardware, or may be implemented by a program instructing relevant hardware. The program may be stored in a computer readable storage medium. The storage medium mentioned above may be a ROM, a magnetic disk, an optical disc, or the like.

The foregoing descriptions are exemplary embodiments of this application, and are not intended to limit this application. Any modification, equivalent replacement, improvement and the like made in the spirit and principle of this application fall in the protection scope of this application.

What is claimed is:

1. An information filtering method, comprising:
obtaining, by an information processing apparatus, shared information that is shared by a user account of an online service;
obtaining a credibility reference rating associated with the user account, the credibility reference rating indicating account credibility of the user account;
determining, by processing circuitry of the information processing apparatus, whether the shared information satisfies a filtering condition based on the credibility reference rating; and
filtering, by the processing circuitry of the information processing apparatus, the shared information when the shared information is determined to satisfy the filtering condition.

2. The method according to claim 1, wherein the filtering condition includes a preset credibility rating and the determining whether the shared information satisfies the filtering condition includes:
determining whether the credibility reference rating is less than the preset credibility rating; and
when the credibility reference rating is determined to be less than the preset credibility rating, determining that the shared information satisfies the filtering condition.

3. The method according to claim 1, wherein the filtering condition includes a first threshold and the determining whether the shared information satisfies the filtering condition includes:
determining first quality information based on the shared information, the first quality information indicating information credibility of the shared information;
determining a release index associated with the shared information based on the credibility reference rating and the first quality information, the release index being positively correlated with the credibility reference rating and the first quality information;
determining whether the release index is less than the first threshold; and
when the release index is determined to be less than the first threshold, determining that the shared information satisfies the filtering condition.

4. The method according to claim 1, wherein the filtering condition includes a first threshold and the determining whether the shared information satisfies the filtering condition includes:
determining second quality information based on additional information shared by the user account in a preset time period and the shared information, the second quality information indicating information credibility of the shared information and the account credibility of the user account;
determining a release index associated with the shared information based on the credibility reference rating and the second quality information, the release index being positively correlated with the credibility reference rating and the second quality information;
determining whether the release index is less than the first threshold; and
when the release index is determined to be less than the first threshold, determining that the shared information satisfies the filtering condition.

5. The method according to claim 1, wherein the filtering condition includes a first threshold and the determining whether the shared information satisfies the filtering condition includes:
determining first quality information based on the shared information, the first quality information indicating information credibility of the shared information;
determining second quality information based on additional information shared by the user account in a preset time period and the shared information, the second quality information indicating the information credibility and the account credibility;
determining a release index associated with the shared information based on the credibility reference rating, the first quality information, and the second quality information, the release index being positively correlated with the credibility reference rating, the first quality information, and the second quality information;
determining whether the release index is less than the first threshold; and
when the release index is determined to be less than the first threshold, determining that the shared information satisfies the filtering condition.

6. The method according to claim 3, wherein the determining the first quality information comprises:
determining a matching degree between the shared information and a preset filter model; and
determining the first quality information based on the matching degree, the first quality information being negatively correlated with the matching degree.

7. The method according to claim 4, wherein the determining the second quality information comprises:
for each of the plurality of additional information shared by the user account in the preset time period,
determining a matching degree between the shared information and the respective additional information; and
identifying the respective additional information as second information when the matching degree is determined to satisfy a matching threshold;
determining a number of the plurality of second information; and
determining the second quality information based on the number of the plurality of second information, the second quality information being negatively correlated with the number.

8. The method according to claim 1, wherein the filtering the shared information comprises:
filtering the shared information to be sent to a target user account, the target user account being identified as corresponding to a friend of the user account.

9. The method according to claim 1, wherein the user account is identified as corresponding to a friend of a target user account of a target user and the method further includes:
obtaining other information shared by a group of user accounts that are identified as corresponding to friends of the target user account;
for each of the plurality of other information, identifying the respective other information as target information when the respective other information fails to satisfy the filtering condition;
including the shared information in the target information when the shared information fails to satisfy the filtering condition;
determining a number of the plurality of target information, the plurality of target information being sent to the target user account for presentation;
determining whether the number of the plurality of target information is larger than a number threshold; and
when the number of the plurality of target information is larger than the number threshold,
obtaining interest information associated with the target user account; and
for each of the plurality of target information shared by one of the group of user accounts,
determining an interest index based on the interest information and a credibility reference rating associated with the one of the group of user accounts, the interest index indicating a degree of interest of the target user in the respective target information;
determining whether the interest index is less than a second threshold; and
when the interest index is determined to be less than the second threshold, filtering the respective target information.

10. The method according to claim 1, wherein the filtering the shared information comprises:
filtering the shared information by deleting the shared information or not sending the shared information to other user accounts that are identified as corresponding to friends of the user account.

11. An information processing apparatus, comprising processing circuitry configured to:
obtain shared information that is shared by a user account of an online service;
obtain a credibility reference rating associated with the user account, the credibility reference rating indicating account credibility of the user account;
determine whether the shared information satisfies a filtering condition based on the credibility reference rating; and
filter the shared information when the shared information is determined to satisfy the filtering condition.

12. The information processing apparatus according to claim 11, wherein the filtering condition includes a preset credibility rating and the processing circuitry is further configured to:
determine whether the credibility reference rating is less than the preset credibility rating; and
when the credibility reference rating is determined to be less than the preset credibility rating, determine that the shared information satisfies the filtering condition.

13. The information processing apparatus according to claim 11, wherein the filtering condition includes a first threshold and the processing circuitry is further configured to:
determine first quality information based on the shared information, the first quality information indicating information credibility of the shared information;
determine a release index associated with the shared information based on the credibility reference rating and the first quality information, the release index being positively correlated with the credibility reference rating and the first quality information;
determine whether the release index is less than the first threshold; and
when the release index is determined to be less than the first threshold, determine that the shared information satisfies the filtering condition.

14. The information processing apparatus according to claim 11, wherein the filtering condition includes a first threshold and the processing circuitry is further configured to:
determine second quality information based on additional information shared by the user account in a preset time period and the shared information, the second quality information indicating information credibility of the shared information and the account credibility of the user account;
determine a release index associated with the shared information based on the credibility reference rating and the second quality information, the release index being positively correlated with the credibility reference rating and the second quality information;
determine whether the release index is less than the first threshold; and
when the release index is determined to be less than the first threshold, determine that the shared information satisfies the filtering condition.

15. The information processing apparatus according to claim 11, wherein the filtering condition includes a first threshold and the processing circuitry is further configured to:
determine first quality information based on the shared information, the first quality information indicating information credibility of the shared information;
determine second quality information based on additional information shared by the user account in a preset time period and the shared information, the second quality information indicating the information credibility and the account credibility;
determine a release index associated with the shared information based on the credibility reference rating, the first quality information, and the second quality information, the release index being positively correlated with the credibility reference rating, the first quality information, and the second quality information;
determine whether the release index is less than the first threshold; and
when the release index is determined to be less than the first threshold, determine that the shared information satisfies the filtering condition.

16. The information processing apparatus according to claim 13, wherein the processing circuitry is further configured to:
determine a matching degree between the shared information and a preset filter model; and
determine the first quality information based on the matching degree, the first quality information being negatively correlated with the matching degree.

17. The information processing apparatus according to claim 14, wherein the processing circuitry is further configured to:
for each of the plurality of additional information shared by the user account in the preset time period,
determine a matching degree between the shared information and the respective additional information; and
identify the respective additional information as second information when the matching degree is determined to satisfy a matching threshold;
determine a number of the plurality of second information; and
determine the second quality information based on the number of the plurality of second information, the second quality information being negatively correlated with the number.

18. The information processing apparatus according to claim 11, wherein the processing circuitry is further configured to:
filter the shared information to be sent to a target user account, the target user account being identified as corresponding to a friend of the user account.

19. The information processing apparatus according to claim 11, wherein the user account is identified as corresponding to a friend of a target user account of a target user and the processing circuitry is further configured to:
obtain other information shared by a group of user accounts that are identified as corresponding to friends of the target user account;
for each of the plurality of other information, identify the respective other information as target information when the respective other information fails to satisfy the filtering condition;
include the shared information in the target information when the shared information fails to satisfy the filtering condition;
determine a number of the plurality of target information, the plurality of target information being sent to the target user account for presentation;
determine whether the number of the plurality of target information is larger than a number threshold; and
when the number of the plurality of target information is larger than the number threshold, obtain interest information associated with the target user account; and
for each of the plurality of target information shared by one of the group of user accounts,
determine an interest index based on the interest information and a credibility reference rating associated with the one of the group of user accounts, the interest index indicating a degree of interest of the target user in the respective target information;
determine whether the interest index is less than a second threshold; and
when the interest index is determined to be less than the second threshold, filter the respective target information.

20. A non-transitory computer-readable storage medium storing a program executable by a processor to perform:
obtaining shared information that is shared by a user account of an online service;
obtaining a credibility reference rating associated with the user account, the credibility reference rating indicating account credibility of the user account;
determining whether the shared information satisfies a filtering condition based on the credibility reference rating; and
filtering the shared information when the shared information is determined to satisfy the filtering condition.
